(19) United States
(12) Patent Application Publication
(10) Pub. No.: US 2026/0039434 A1
(43) Pub. Date: Feb. 5, 2026

(54) TERMINAL, RADIO COMMUNICATION METHOD, AND BASE STATION

(71) Applicant: NTT DOCOMO, INC., Tokyo (JP)

(72) Inventors: Naoya SHIBAIKE, Tokyo (JP); Yuki MATSUMURA, Tokyo (JP); Satoshi NAGATA, Tokyo (JP); Jing WANG, Beijing (CN)

(73) Assignee: NTT DOCOMO, INC., Tokyo (JP)

(21) Appl. No.: 19/099,503

(22) PCT Filed: Aug. 1, 2022
(86) PCT No.: PCT/JP2022/029472

§ 371 Date: Jan. 29, 2025

(51) Int. Cl. H04L 5/00; H04W 72/21

(52) U.S. Cl. CPC H04L 5/0051; H04W 72/21

(57) ABSTRACT

A terminal according to one aspect of the present disclosure includes: a receiving section that receives an indication of transmission of a physical uplink shared channel (PUSCH) using more than four layers; and a control section that determines a transmission power ratio between a phase tracking reference signal (PTRS) and the PUSCH. According to one aspect of the present disclosure, it is possible to appropriately control UL transmission using more than four antenna ports.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (Non-Patent Literature 1). In addition, for the purpose of further high capacity, advancement and the like of LTE (Third Generation Partnership Project (3GPP (registered trademark)) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+ (plus),” “6th generation mobile communication system (6G),” “New Radio (NR),” “3GPP Rel. 15 (or later versions),” and so on) are also under study.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

In Rel-15 NR, uplink (UL) Multi Input Multi Output (MIMO) transmission with up to four layers is supported. For future NR, to achieve higher spectral efficiency, it is studied to support UL transmission with the number of layers larger than four layers. For example, for Rel-18 NR, 6-rank maximum transmission using six antenna ports, 6-or-8-rank maximum transmission using eight antenna ports, and the like are studied.

However, study has not advanced how to determine transmission power for UL transmission using more than four antenna ports. For example, study about a relationship of transmission power between a phase tracking reference signal (PTRS) and a physical uplink shared channel (PUSCH) and the like has not advanced. Unless this is made clear, an increase in communication throughput may be suppressed.

Thus, an object of the present disclosure is to provide a terminal, a radio communication method, and a base station that enable appropriate control of UL transmission using more than four antenna ports.

### Solution to Problem

A terminal according to one aspect of the present disclosure includes: a receiving section that receives an indication of transmission of a physical uplink shared channel (PUSCH) using more than four layers; and a control section that determines a transmission power ratio between a phase tracking reference signal (PTRS) and the PUSCH.

### Advantageous Effects of Invention

According to one aspect of the present disclosure, it is possible to appropriately control UL transmission using more than four antenna ports.

### BRIEF DESCRIPTION OF DRAWINGS

FIG. 1 is a diagram to show an example of a table of precoding matrices W for single-layer (rank 1) transmission using four antenna ports when a transform precoder is disabled in Rel-16 NR.

FIG. 2 is a diagram to show an example of a table of precoding matrices W for two-layer (rank 2) transmission using four antenna ports when a transform precoder is disabled in Rel-16 NR.

FIG. 3 is a diagram to show an example of a table of precoding matrices W for three-layer (rank 3) transmission using four antenna ports when a transform precoder is disabled in Rel-16 NR.

FIG. 4 is a diagram to show an example of a table of precoding matrices W for four-layer (rank 4) transmission using four antenna ports when a transform precoder is disabled in Rel-16 NR.

FIG. 5A is a diagram to show an example of a table of precoding matrices W for single-layer (rank 1) transmission using two antenna ports in Rel-16 NR. FIG. 5B is a diagram to show an example of a table of precoding matrices W for two-layer (rank 2) transmission using two antenna ports when transform precoding is disabled in Rel-16 NR.

FIG. 6 is a diagram to show an example of correspondence between values of a precoding information and number of layers field and the numbers of layers and TPMIs in Rel-16 NR.

FIG. 7 shows an example of non-coherent precoding matrices W for selecting one port.

FIG. 8 shows an example of partial-coherent precoding matrices W for selecting two ports.

FIGS. 9A to 9C show examples of PC capability.

FIGS. 10A and 10B show an example of association between PTRS ports and DMRS ports.

FIG. 11 shows an example of a PUSCH-to-PTRS power ratio per layer per RE.

FIG. 12 shows an example of a PT-RS EPRE to PDSCH EPRE ratio per layer per RE for a PT-RS port.

FIG. 13 shows an example of a structure of a plurality of antenna ports according to embodiment #1.

FIGS. 14A and 14B show examples of a structure of a plurality of antenna ports according to option 2 of embodiment #2.

FIGS. 15A and 15B show examples of a structure of a plurality of antenna ports according to option 2 of embodiment #3.

FIGS. 16A and 16B show examples of a structure of a plurality of antenna ports according to option 3 of embodiment #3.

FIGS. 17A and 17B show examples of a structure of a plurality of antenna ports according to option 4 of embodiment #3.

FIGS. 18A and 18B show other examples of the structure of the plurality of antenna ports according to option 4 of embodiment #3.

FIG. 19 shows an example of a PUSCH-to-PTRS ratio per layer per RE according to embodiment #4.

FIG. 20 shows another example of the PUSCH-to-PTRS power ratio per layer per RE according to embodiment #4.

FIG. 21 shows still another example of the PUSCH-to-PTRS ratio per layer per RE according to embodiment #4.

FIG. 22 is a diagram to show an example of a schematic structure of a radio communication system according to one embodiment.

FIG. 23 is a diagram to show an example of a structure of a base station according to one embodiment.

FIG. 24 is a diagram to show an example of a structure of a user terminal according to one embodiment.

FIG. 25 is a diagram to show an example of a hardware structure of the base station and the user terminal according to one embodiment.

FIG. 26 is a diagram to show an example of a vehicle according to one embodiment.

### DESCRIPTION OF EMBODIMENTS

### Control of SRS and PUSCH Transmission

In Rel-15 NR, a terminal (user terminal, User Equipment (UE)) may receive information to be used for transmission of a reference signal for measurement (for example, sounding reference signal (SRS)) (SRS configuration information, for example, a parameter in an RRC control element “SRS-Config”).

Specifically, the UE may receive at least one of information related to one or a plurality of SRS resource sets (SRS resource set information, for example, an RRC control element “SRS-ResourceSet”) and information related to one or a plurality of SRS resources (SRS resource information, for example an RRC control element “SRS-Resource”).

One SRS resource set may be related to a certain number of SRS resources (may group the certain number of SRS resources). Each SRS resource may be identified by an SRS resource indicator (SRI) or an SRS resource ID (Identifier).

The SRS resource set information may include an SRS resource set ID (SRS-ResourceSetId), a list of SRS resource IDs (SRS-ResourceId) used in the resource set, an SRS resource type, and information of SRS usage.

Here, the SRS resource type may indicate any of periodic SRS (P-SRS), semi-persistent SRS (SP-SRS), and aperiodic CSI (Aperiodic SRS (A-SRS)). Note that the UE may transmit a P-SRS and an SP-SRS periodically (or periodically after activation), and transmit an A-SRS, based on an SRS request of DCI.

The usage (RRC parameter “usage,” L1 (Layer-1) parameter “SRS-SetUse”) may be, for example, beam management (beamManagement), codebook (CB), non-codebook (noncodebook (NCB)), antenna switching, or the like. An SRS with codebook or non-codebook usage may be used to determine a precoder for codebook based or non-codebook based uplink shared channel (Physical Uplink Shared Channel (PUSCH)) transmission based on an SRI.

For example, in a case of codebook-based transmission, the UE may determine a precoder (precoding matrix) for the PUSCH transmission, based on the SRI, a transmitted rank indicator (TRI), a transmitted precoding matrix indicator (TPMI), and the like. In a case of non-codebook-based transmission, the UE may determine a precoder for the PUSCH transmission, based on the SRI.

The SRS resource information may include an SRS resource ID (SRS-ResourceId), the number of SRS ports, SRS port numbers, transmission Comb, SRS resource mapping (for example, time and/or frequency resource location, a resource offset, resource periodicity, the number of repetitions, the number of SRS symbols, an SRS bandwidth, and the like), hopping related information, an SRS resource type, a sequence ID, spatial relation information of an SRS, and the like.

The spatial relation information of an SRS (for example, an RRC information element “spatialRelationInfo”) may indicate spatial relation information between a certain reference signal and an SRS. The certain reference signal may be at least one of a synchronization signal/broadcast channel (Synchronization Signal/Physical Broadcast Channel (SS/PBCH)) block, a channel state information reference signal (CSI-RS), and an SRS (for example, another SRS). The SS/PBCH block may be referred to as a synchronization signal block (SSB).

The spatial relation information of an SRS may include at least one of an SSB index, a CSI-RS resource ID, and an SRS resource ID, as an index of the certain reference signal.

Note that, in the present disclosure, an SSB index, an SSB resource ID, and an SSB Resource Indicator (SSBRI) may be interchangeably interpreted. A CSI-RS index, a CSI-RS resource ID, and a CSI-RS Resource Indicator (CRI) may be interchangeably interpreted. An SRS index, an SRS resource ID, and an SRI may be interchangeably interpreted.

The spatial relation information of an SRS may include a serving cell index, a BWP index (BWP ID), and the like corresponding to the certain reference signal.

When spatial relation information related to an SSB or a CSI-RS and an SRS is configured for a certain SRS resource, the UE may transmit the SRS resource by using the same spatial domain filter (spatial domain transmission filter) as the spatial domain filter for reception (spatial domain receive filter) of the SSB or the CSI-RS. In this case, the UE may assume that a UE receive beam of the SSB or the CSI-RS and a UE transmit beam of the SRS are the same.

When the UE is configured, for a certain SRS (target SRS) resource, with spatial relation information related to another SRS (reference SRS) and a certain SRS (target SRS), the UE may transmit the target SRS resource by using the same spatial domain filter (spatial domain transmission filter) as the spatial domain filter for transmission (spatial domain transmission filter) of the reference SRS. In other words, in this case, the UE may assume that a UE transmit beam of the reference SRS and a UE transmit beam of the target SRS are the same.

The UE may determine a spatial relation of a PUSCH scheduled by DCI (for example, DCI format 0_1), based on the value of a certain field (for example, an SRS resource indicator (SRI) field) in the DCI. Specifically, the UE may use, for PUSCH transmission, spatial relation information of an SRS resource determined based on the value (for example, the SRI) of the certain field (for example, an RRC information element “spatialRelationInfo”).

In Rel-15/16 NR, when codebook-based transmission is used for a PUSCH, a UE may be configured with an SRS resource set including two SRS resources at maximum with codebook usage, by RRC, and may be indicated with one of the two SRS resources at maximum by DCI (1-bit SRI field). A transmit beam for the PUSCH may be specified by the SRI field.

The UE may judge a TPMI and the number of layers (transmission rank) for the PUSCH, based on the precoding information and number of layers field (also referred to as a precoding information field below). The UE may select a precoder from a codebook for uplink for the same number of ports as the number of SRS ports indicated by a higher layer parameter “nrofSRS-Ports” configured for an SRS resource specified by the SRI field, based on the TPMI, the number of layers, and the like.

In Rel-15/16 NR, when non-codebook-based transmission is used for a PUSCH, the UE may be configured with an SRS resource set including four SRS resources at maximum with non-codebook usage, by RRC, and may be indicated with one or more of the four SRS resources at maximum by DCI (2-bit SRI field).

The UE may determine the number of layers (transmission rank) for the PUSCH, based on the SRI field. For example, the UE may judge that the number of SRS resources indicated by the SRI field is the same as the number of layers for the PUSCH. The UE may calculate a precoder for the SRS resource.

When a CSI-RS related to the SRS resource (or SRS resource set to which the SRS resource belongs) (which may be referred to as an associated CSI-RS) is configured in a higher layer, a transmit beam for the PUSCH may be calculated based on (measurement of) the configured related CSI-RS. Otherwise, a transmit beam for the PUSCH may be specified by an SRI.

Note that the UE may be configured with whether to use codebook based PUSCH transmission or use non-codebook based PUSCH transmission by a higher layer parameter “txConfig” indicating a transmission scheme. The parameter may indicate a value of “codebook” or “non-codebook (nonCodebook).”

In the present disclosure, a codebook based PUSCH (codebook based PUSCH transmission, codebook based transmission) may mean a PUSCH when the UE is configured with “codebook” as a transmission scheme. In the present disclosure, a non-codebook based PUSCH (non-codebook based PUSCH transmission, non-codebook based transmission) may mean a PUSCH when the UE is configured with “non-codebook” as a transmission scheme.

### Determination of PUSCH Precoder in Codebook (CB)-Based Transmission

As described above, in a case of codebook (CB)-based transmission, a UE may determine a precoder for PUSCH transmission, based on an SRI, a TRI, a TPMI, and the like.

The UE may be notified of the SRI, the TRI, the TPMI, and the like by using downlink control information (DCI). The SRI may be specified by an SRS Resource Indicator field (SRI field) of the DCI or may be specified by a parameter “srs-ResourceIndicator” included in an RRC information element “ConfiguredGrantConfig” for a configured grant PUSCH.

The TRI and the TPMI may be specified by precoding information and number of layers field (“Precoding information and number of layers” field) of the DCI. The precoding information and number of layers field is also referred to as a precoding information field, for simplicity.

The UE may report UE capability information related to a precoder type and be configured, by a base station, with the precoder type based on the UE capability information by higher layer signaling. The UE capability information may be precoder type information to be used by the UE in PUSCH transmission (which may, for example, be indicated by an RRC parameter “pusch-TransCoherence”).

The UE may determine a precoder to be used for the PUSCH transmission, based on precoder type information (for example, an RRC parameter “codebookSubset”) included in PUSCH configuration information notified by higher layer signaling (for example, an information element “PUSCH-Config” of RRC signaling). The UE may be configured with a subset of the PMI specified by the TPMI, by codebookSubset.

Note that the precoder type may be specified by any of or a combination of at least two of full coherent, partial coherent, and non-coherent (non coherent) (which may be indicated, for example, by a parameter such as “fullyAndPartialAndNonCoherent” or “partialAndNonCoherent.”

For example, an RRC parameter “pusch-TransCoherence” indicating UE capability may indicate full coherent (fullCoherent), partial coherent (partialCoherent), or non-coherent (nonCoherent). An RRC parameter “codebookSubset” may indicate “fully, partial, and non-coherent (fullyAndPartialAndNonCoherent),” “partial and non-coherent (partialAndNonCoherent),” or “non-coherent (nonCoherent).”

Full coherent may mean that all the antenna ports to be used for transmission are synchronized (which may be expressed as being able to be co-phased for each coherent antenna port, appropriately applying a precoder for each coherent antenna port, and the like). Partial coherent may mean that some ports of the antenna ports to be used for transmission are synchronized but the ports and the other ports are not synchronized. Non-coherent may mean that the antenna ports to be used for transmission are not synchronized.

Note that a UE that supports the precoder type, full coherent, may be assumed to support the precoder types, partial coherent and non-coherent. A UE that supports the precoder type, partial coherent, may be assumed to support the precoder type, non-coherent.

In the present disclosure, a precoder type, coherency, PUSCH transmission coherence, a coherent type, a coherence type, a codebook type, a codebook subset, a codebook subset type, and the like may be interchangeably interpreted.

The UE may determine a precoding matrix corresponding to the TPMI index obtained from DCI for scheduling UL transmission (for example, DCI format 0_1, this similarly applies below), from a plurality of precoders (which may be referred to as a precoding matrix, a codebook, and the like) for CB-based transmission.

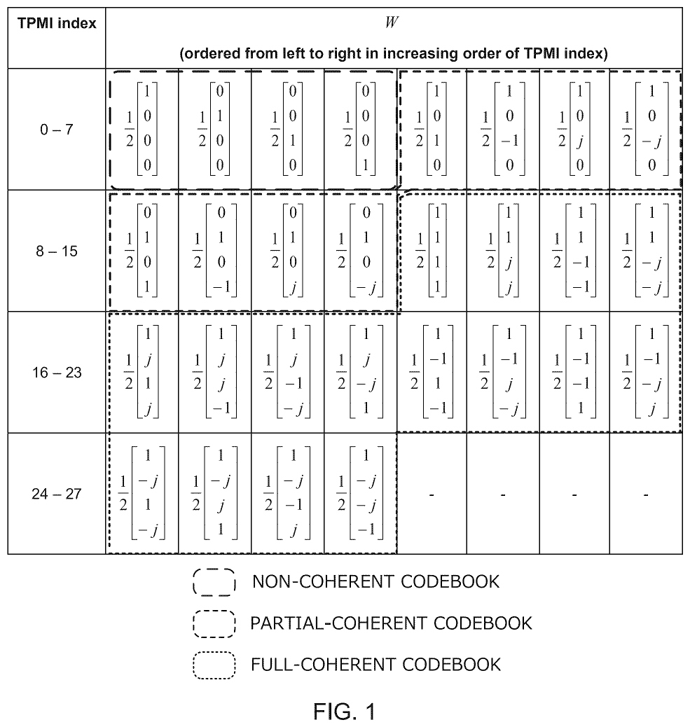

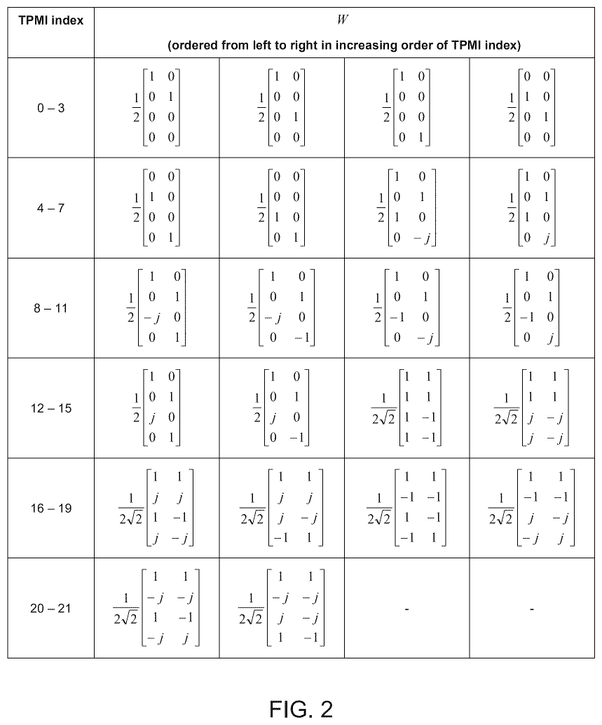

FIG. 1 is a diagram to show an example of association between codebook subsets and corresponding TPMI indices. FIG. 1 corresponds to a table of precoding matrices W for single-layer (rank 1) transmission using four antenna ports when transform precoding (which may be referred to as a transform precoder) is disabled, in Rel-16 NR. FIG. 1 shows corresponding W in increasing order of TPMI indices from left to right (this similarly applies to FIG. 2).

The correspondence (which may be referred to as a table) showing W corresponding to TPMI indices as that shown in FIG. 1 is also referred to as a codebook. Part of this codebook is also referred to as a codebook subset.

In FIG. 1, when a codebook subset (codebookSubset) corresponds to fullyAndPartialAndNonCoherent, a UE is notified of any TPMI (TPMI index) of 0 to 27 for single-layer transmission. When a codebook subset corresponds to partialAndNonCoherent, the UE is configured with any TPMI of 0 to 11 for single-layer transmission. When a codebook subset corresponds to nonCoherent, the UE is configured with any TPMI of 0 to 3 for single-layer transmission.

In FIG. 1, when a TPMI of 0 to 3 is notified, a precoder for non-coherent is applied. When a TPMI of 4 to 11 is notified, a precoder for partial coherent is applied. When a TPMI of 12 to 27 is notified, a precoder for full coherent is applied.

FIG. 2 each corresponds to a table of precoding matrices W for 2-4 layer (rank 2-4) transmission using four antenna ports when transform precoding is disabled, in Rel-16 NR.

According to FIG. 2, a TPMI of which a UE is notified for 2-layer transmission is any of 0 to 21 (codebook subset corresponding to fullyAndPartialAndNonCoherent), 0 to 13 (codebook subset corresponding to partialAndNonCoherent), or 0 to 5 (codebook subset corresponding to nonCoherent).

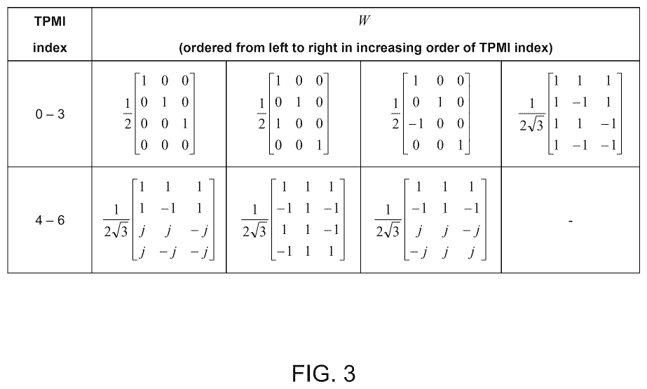

According to FIG. 3, a TPMI of which a UE is notified for 3-layer transmission is any of 0 to 6 (codebook subset corresponding to fullyAndPartialAndNonCoherent), 0 to 2 (codebook subset corresponding to partialAndNonCoherent), or 0 (codebook subset corresponding to nonCoherent).

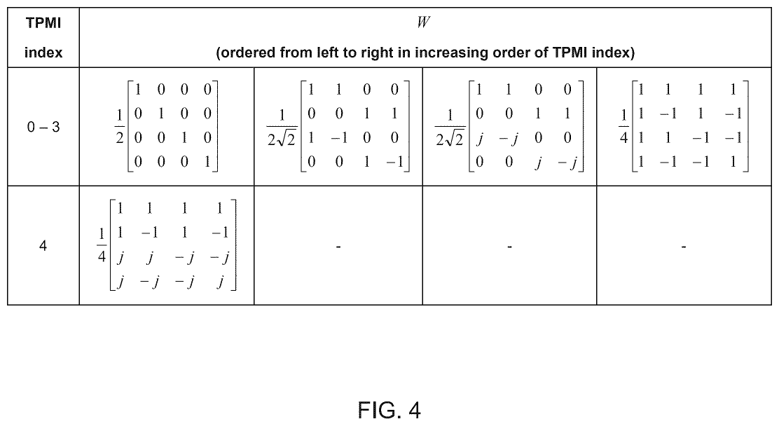

According to FIG. 4, a TPMI of which a UE is notified for 4-layer transmission is any of 0 to 4 (codebook subset corresponding to fullyAndPartialAndNonCoherent), 0 to 2 (codebook subset corresponding to partialAndNonCoherent), or 0 (codebook subset corresponding to nonCoherent).

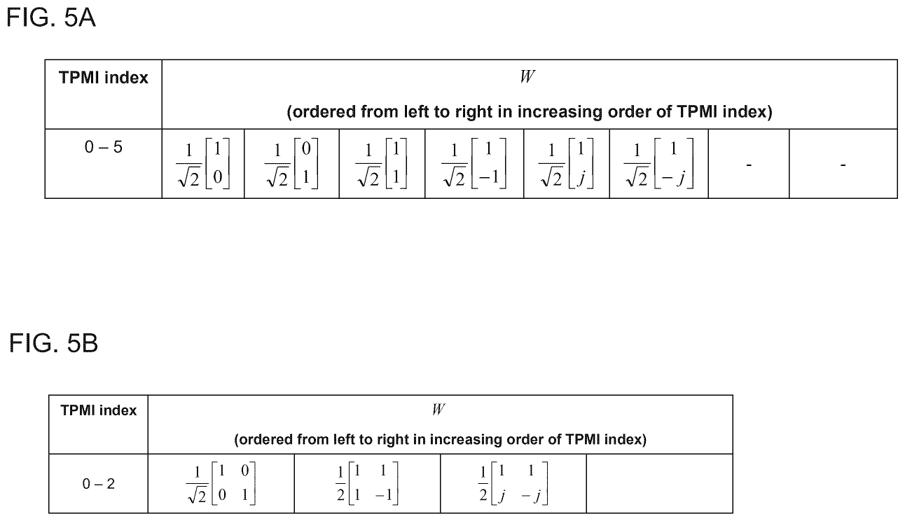

FIG. 5A corresponds to a table of precoding matrices W for single-layer (rank 1) transmission using two antenna ports, in Rel-16 NR. FIG. 5B corresponds to a table of precoding matrices W for 2-layer (rank 2) transmission using two antenna ports when transform precoding is disabled, in Rel-16 NR.

According to FIG. 5A, a TPMI of which a UE is notified for 2-port single-layer transmission is any of 0 to 5 (codebook subset corresponding to fullyAndPartialAndNonCoherent) or 0 and 1 (codebook subset corresponding to nonCoherent). When a notified TPMI is any of 0 and 1, a precoder for non-coherent is applied. When a notified TPMI is any of 2 to 5, a precoder for full coherent is applied.

According to FIG. 5B, a TPMI of which a UE is notified for 2-port 2-layer transmission is any of 0 to 2 (codebook subset corresponding to fullyAndPartialAndNonCoherent) or 0 (codebook subset corresponding to nonCoherent).

Note that a precoding matrix having only one element not being 0 per column may be referred to as a non-coherent codebook. A precoding matrix having only a certain number of elements not being 0 per column (the certain number being larger than one but being not the number of all the elements per column) may be referred to as a partial-coherent codebook. A precoding matrix having none of all the elements being 0 per column may be referred to as a full-coherent codebook.

A non-coherent codebook and a partial-coherent codebook may be referred to as antenna selection precoders, antenna port selection precoders, and the like. For example, a non-coherent codebook (non-coherent precoder) may be referred to as a 1-port selection precoder, 1-port port selection precoder, and the like. A partial-coherent codebook (partial-coherent precoder) may be referred to as an x-port (x is an integer larger than 1) selection precoder, x-port port selection precoder, and the like. A full-coherent codebook may be referred to as a non-antenna selection precoder, all-port precoder, and the like.

Note that, in the present disclosure, a partial-coherent codebook may correspond to codebooks (precoding matrices) obtained by a UE configured with a partial-coherent codebook subset (for example, RRC parameter “codebookSubset”=“partialAndNonCoherent”) excluding codebooks corresponding to TPMIs specified to a UE configured with a non-coherent codebook subset (for example, RRC parameter “codebookSubset”=“nonCoherent”) from codebooks corresponding to TPMIs specified by DCI for codebook-based transmission (specifically, in a case of 4-antenna-port single-layer transmission, codebooks for TPMIs of 4 to 11 (TPMI=4 to 11)).

Note that, in the present disclosure, a full-coherent codebook may correspond to codebooks (precoding matrices) obtained by a UE configured with a full-coherent codebook subset (for example, RRC parameter “codebookSubset”=“fullyAndPartialAndNonCoherent”) excluding codebooks corresponding to TPMIs specified to a UE configured with a partial-coherent codebook subset (for example, RRC parameter “codebookSubset”=“partialAndNonCoherent”) from codebooks corresponding to TPMIs specified by DCI for codebook-based transmission (specifically, in a case of 4-antenna-port single-layer transmission, codebooks for TPMIs of 12 to 27 (TPMI=12 to 27)).

Note that, as seen from FIGS. 5A and 5B, since there is no partial-coherent precoder for 2-antenna-port transmission, no configuration with a codebook subset being partial and non-coherent may be applied for two antenna ports.

### Precoding Information Field

As described above, a UE may judge a TPMI and the number of layers (transmission rank) for a PUSCH, based on a precoding information field of DCI (for example, DCI format 0_1/0_2) for scheduling the PUSCH.

For a codebook-based PUSCH, the number of bits of the precoding information field may be judged (may vary) based on a configuration of a transform precoder for the PUSCH being enabled/disabled (for example, a higher layer parameter transformPrecoder), a configuration of a codebook subset for the PUSCH (for example, a higher layer parameter codebookSubset), a configuration of a maximum number of layers for the PUSCH (for example, a higher layer parameter maxRank), a configuration of uplink full power transmission for the PUSCH (for example, a higher layer parameter ul-FullPowerTransmission), the number of antenna ports for PUSCH, and the like.

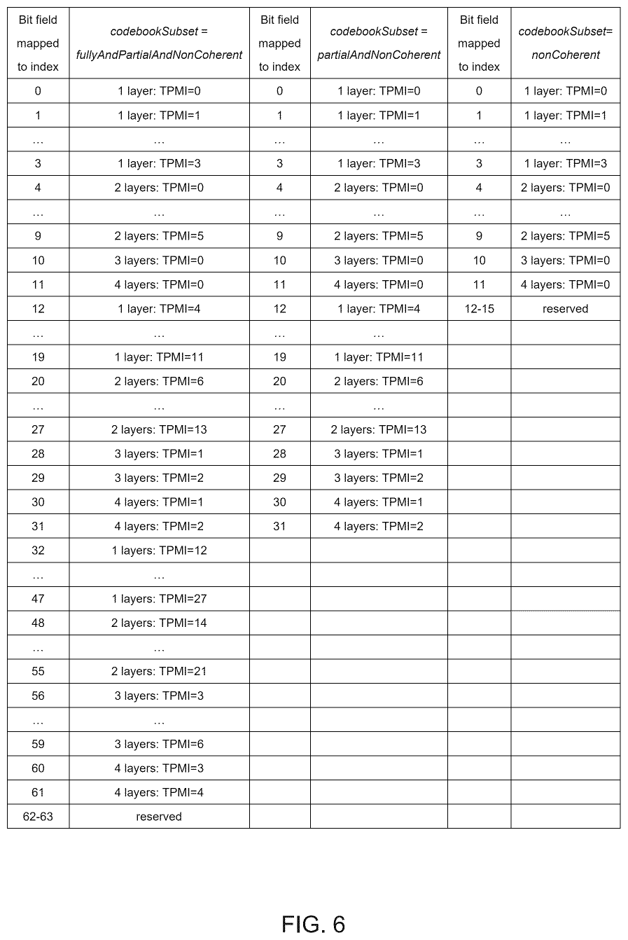

FIG. 6 is a diagram to show an example of correspondence between values of a precoding information and number of layers field and the numbers of layers and TPMIs in Rel-16 NR. The correspondence of this example is correspondence for four antenna ports in a case where a transform precoder is configured at disabled, where the maximum rank (maxRank) is configured at 2, 3, or 4, and where uplink full power transmission is not configured, configured at fullpowerMode2, or configured at fullpower, but is not restrictive. Note that it is naturally understood by those skilled in the art that the “bit field mapped to index” shown in FIG. 6 indicates a value of the precoding information and number of layers field.

In FIG. 6, the precoding information field is constituted of 6 bits when a full-coherent (fullyAndPartialAndNonCoherent) codebook subset is configured for a UE, 5 bits when a partial-coherent (partialAndNonCoherent) codebook subset is configured for the UE, and 4 bits when a non-coherent (nonCoherent) codebook subset is configured for the UE.

Note that, as shown in FIG. 6, the number of layers and a TPMI corresponding to a certain value of the precoding information field may be the same (in common) irrespective of codebook subset configured for the UE. For example, in FIG. 6, the numbers of layers and the TPMIs indicated by the values of the precoding information field=0 to 11 for full-coherent (fullyAndPartialAndNonCoherent), partial-coherent (partialAndNonCoherent), and non-coherent (nonCoherent) codebook subsets may be the same. In FIG. 6, the numbers of layers and the TPMIs indicated by the values of the precoding information field=0 to 31 for full-coherent (fullyAndPartialAndNonCoherent) and partial-coherent (partialAndNonCoherent) codebook subsets may be the same.

Note that the precoding information field may be 0 bits for a non-codebook-based PUSCH. The precoding information field may be 0 bits for a 1-antenna-port codebook-based PUSCH.

### Transmission Using More Than Four Antenna Ports

In Rel-15/16 NR, uplink (UL) Multi Input Multi Output (MIMO) transmission with up to four layers is supported. For future radio communication systems, to achieve higher spectrum efficiency, it is studied to support UL transmission with the number of layers larger than four. For example, for Rel-18 NR, 6-rank maximum transmission using six antenna ports, 6-or-8-rank maximum transmission using eight antenna ports, and the like are studied.

A precoding matrix for UL transmission using more than four antenna ports (antenna ports the number of which is larger than four) is studied. For example, a codebook for 8-port transmission (which may be referred to as 8-transmission UL codebook (8 TX UL codebook) and the like) is studied.

A non-coherent codebook from one layer to eight ports may be used.

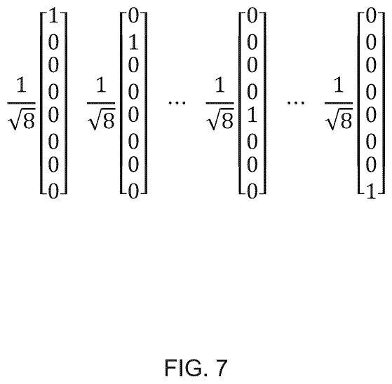

FIG. 7 shows an example of non-coherent precoding matrices W for selecting one port.

By supporting a plurality of port selection precoding matrices, transmission antenna switching can be performed. Note that it is not necessary to support all the above-described eight precoding matrices. Only two matrices of the eight precoding matrices may be supported.

Note that a precoding matrix (precoder) for eight ports in the present disclosure is scaled (adjusted) so that a coefficient (or the absolute value of each component) takes 1/√8 (or a specific value), but this is not restrictive.

A partial-coherent codebook from one layer to eight ports may be used.

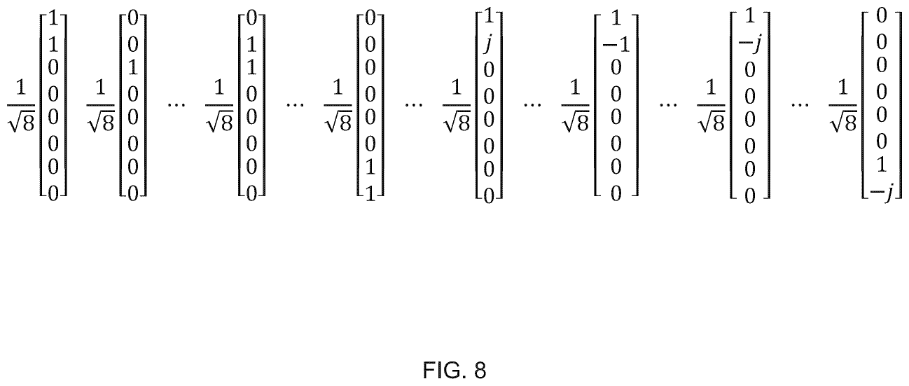

FIG. 8 shows an example of partial-coherent precoding matrices W for selecting two ports. With this codebook, x ports (1<x<8) may be selected. When a first port is selected, the value of an element for the port may be 1. The value of an element for each of the selected port(s) excluding the first port may be any one from {1, j, −1, −j}. The number of possible combinations of selected x ports may be M. For two-port selection, M=C₈²=28 may hold. For four-port selection, M=C₈⁴=70 may hold. For six-port selection, M=C₈⁶=28 may hold. In consideration of four possible phases {1, j, −1, −j} for each of the port(s) excluding the first port, the number of possible combinations of codebooks may be M*4(x−1).

For an 8-transmission UL codebook, one or more UE coherent assumptions (UE coherent capabilities) and one or more codebook subset configurations may be applied.

For eight ports, “pusch-TransCoherence” and “codebookSubset,” which are existing RRC parameters (or UE capabilities), and the like may be used. For example, for eight ports, the UE may judge a TPMI index for an 8-transmission UL codebook, based on non-coherent (nonCoherent), partial coherent (partialCoherent), full-coherent (fullCoherent), “partial and non-coherent (partialAndNonCoherent),” “full and partial and non-coherent (fullyAndPartialAndNonCoherent),” and the like.

For eight ports, a new RRC parameter (or UE capability) may be used. For example, the UE may report, to a network (for example, a base station), capability information indicating supporting of full/partial/non-coherent of a specific number of ports or less, or may be configured with an RRC parameter indicating use of a full/partial/non-coherent codebook subset for transmission of a specific number of ports or less.

For eight ports, the UE may report or the UE may be configured with information indicating ports being coherent (or ports to be used as being coherent).

For eight ports, the UE that supports partial coherent (having capability of partial coherent) may transmit (by including in capability information) information related to which combination of antenna ports is coherent. This information may be referred to as coherent information, coherent port information, and the like.

The coherent port information may be a bitmap having the size corresponding to the number of ports and indicate, for example, the ports corresponding to a bit being ‘1’ (or ‘0’) are coherent with each other.

The coherent port information may be information related to a coherent group. Here, the coherent group may include X (X is an integer being one or more) coherent port(s). The information related to a coherent group may indicate that a certain coherent group includes X ports or may indicate a port number (port index) of each of X coherent ports included in a certain coherent group.

The UE may report UE capability information related to one or a plurality of coherent groups to the network.

An antenna included in a certain coherent group and an antenna included in another coherent group are not coherent with each other.

Note that one coherent group may be further divided into a plurality of coherent groups. With such coherent group classification, flexible control can be expected to be enabled.

In the present disclosure “having capability of a coherent group” may be interpreted as “having capability of supporting a coherent group,” “possible to use a coherent group,” and the like, and vice versa.

The 8-transmission UL codebook for PUSCH above may be used for a case where at least one of the following is satisfied:
case where a transform precoder for PUSCH is configured at disabled for the UE
case where the number of ports being more than four for PUSCH/SRS (for CB based PUSCH) is configured for the UE by RRC
case where the number of ports being more than four for PUSCH/SRS (for CB based PUSCH) is configured/activated/indicated for the UE by RRC/MAC CE/DCI

A precoding matrix for how many ports being to be used may be semi-statically configured by RRC. Fallback (or switching or switch) from use of a precoding matrix for more than four ports to use of a precoding matrix for four ports or less may be dynamically performed by a MAC CE/DCI.

Note that the UE may use (refer to) a common 8-transmission UL codebook irrespective of antenna layout (antenna structure). Note that the UE may use (refer to) a different 8-transmission UL codebook for each antenna layout (antenna structure).

The UE may report UE capability information related to antenna layout. The base station may transmit, to the UE, information indicating/specifying/configuring an 8-transmission UL codebook to be used by the UE, based on the UE capability information, for example. The UE may judge an 8-transmission UL codebook to use, based on the UE capability information that the UE has reported and the information indicating/specifying/configuring the 8-transmission UL codebook that the UE has received.

In the present disclosure, coherent port information, UE capability information related to antenna layout, and the like may be referred to as antenna capability information.

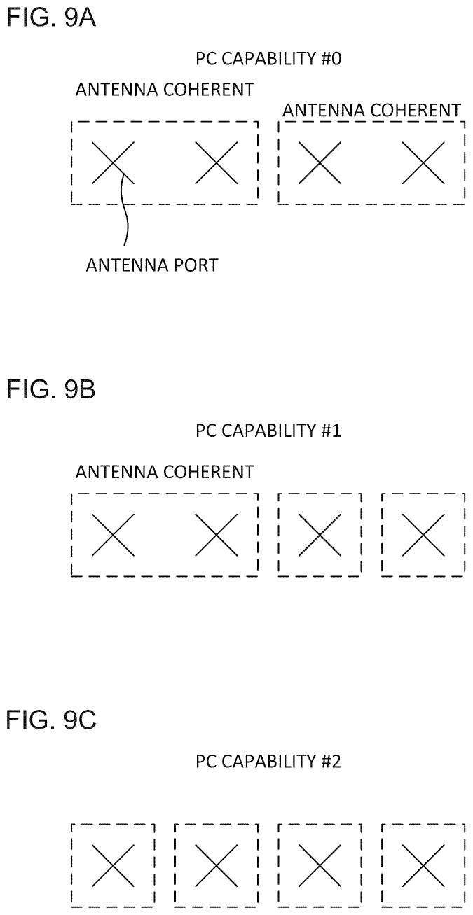

A UE reporting capability information for 8 Tx partial coherent may support or report one or more UE antenna coherent capabilities. Antenna ports (the number of antenna ports or antenna port indices) in each coherent group may be reported. Partial-coherent capability #0 in the example in FIG. 9A supports a coherent group with four ports and a coherent group with four ports. Partial-coherent capability #1 in the example in FIG. 9B supports a coherent group with four ports, a coherent group with two ports, and a coherent group with two ports. Partial-coherent capability #2 in the example in FIG. 9C supports four coherent groups each with two ports.

### Association Between PTRS Ports and DMRS Ports

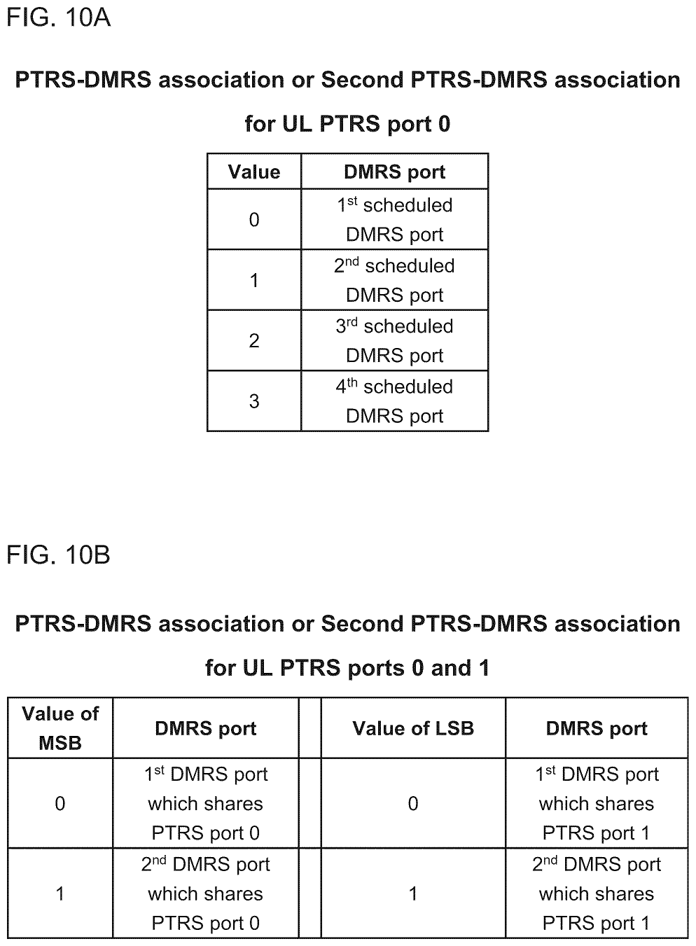

Association between PTRS ports and DMRS ports is indicated by “PTRS-DMRS association” field in DCI. For a Rel-16/17 PUSCH, up to two UL PTRS ports are supported. If one PTRS port is configured, PTRS-DMRS association is indicated by the PTRS-DMRS association field by using FIG. 10A. If two PTRS ports are configured, PTRS-DMRS association is indicated by the PTRS-DMRS association field by using FIG. 10B.

If two PTRS ports are configured, “DMRS ports sharing a PTRS port” may follow the following.
PUSCH antenna ports 1000 and 1002 in an indicated TPMI share PTRS port 0. PUSCH antenna ports 1001 and 1003 in the indicated TPMI share PTRS port 1. UL PTRS port 0 is associated with UL layer ‘x’ of a plurality of layers transmitted by using the PUSCH antenna ports 1000 and 1002 in the indicated TPMI. UL PTRS port 1 is associated with UL layer ‘y’ of a plurality of layers transmitted by using the PUSCH antenna ports 1001 and 1003 in the indicated TPMI. Here, ‘x’ and/or ‘y’ are given by a DCI parameter PTRS-DMRS association indicated in DCI format 0_1 and DCI format 0_2.

### EXAMPLE

For a TPMI, layers 0/1/2/3 are transmitted respectively by using PUSCH antenna ports 1000/1001/1002/1003, DMRS ports corresponding to layers 0/2 share PTRS port 0, and DMRS ports corresponding to layers 1/3 share PTRS port 1.

### Transmission Power Ratio Between PTRS and PUSCH

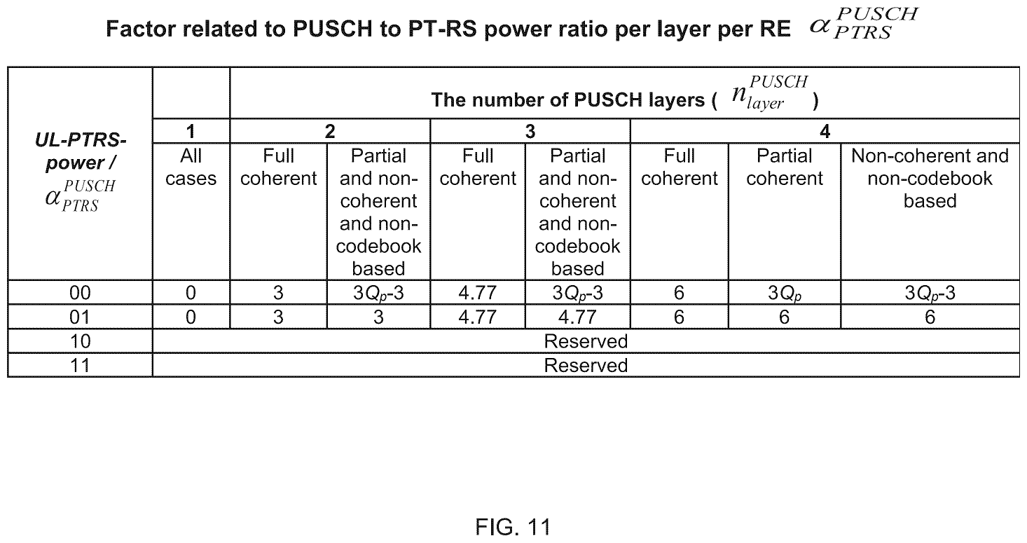

A UE may be scheduled with Q_{P}={1, 2} PTRS port(s) in UL and the number of layers to be scheduled is n_{layer}^{PUSCH}, the UE may follow the following procedure.
If the UE is configured with a higher layer parameter ptrs-Power (UL-PTRS-power), a PUSCH-to-PTRS power ratio ρ_{PTRS}^{PUSCH} per layer per RE is given by ρ_{PTRS}^{PUSCH}=−α_{PTRS}^{PUSCH} [dB]. Here, α_{PTRS}^{PUSCH} is indicated by a table (association) in FIG. 11 according to the higher layer parameter ptrs-Power, and a PTRS scaling factor β_{PTRS} is given by β_{PTRS}=10\hat{ } (−ρ_{PTRS}^{PUSCH}/20) and the precoding information and number of layers field ‘Precoding Information and Number of Layers’ in DCI.
When ptrs-Power in PTRS-Config is not configured, or in a case of a non-codebook based PUSCH, ptrs-Power in PTRS-Config, the UE assumes that ptrs-Power in PTRS-Config is set at a state ‘00’ in the table.

In full coherent, the number of PTRS ports is always one.

One PTRS port is precoded by a (number of ports*number of layers=1) precoding matrix. A PUSCH(s) of X layer(s) is precoded by (number of ports*number of layers) precoding matrix (matrices). Thus, the PTRS-to-PUSCH transmission power ratio per RE per layer is 10log₁₀ (number of PUSCH layers) [dB].

In non-coherent, the number of PTRS ports is one or two.

In a case of UL-PTRS-power=“00,” the PTRS port(s) borrows power from a different RE of the same layer (RE used for a PTRS on the different port). If the number of PTRS ports is one, no power increase is made. If the number of PTRS ports is two, in contrast, the RE for the PTRS on the other port is muted, and the power of the RE is borrowed.

In a case of UL-PTRS-power=“01,” the PTRS port(s) borrows power from the same RE of a different layer. Thus, it is always supported that the PTRS-to-PUSCH transmission power ratio per RE per layer is 10log₁₀ (number of PUSCH layers) [dB].

In partial coherent, the number of PTRS ports is one or two.

In a case of UL-PTRS-power=“00,” a combination of two power borrowing (use) schemes is used. The two schemes are a scheme of borrowing power from a different RE of the same layer (RE used for a PTRS on a different port) and a scheme of borrowing power from the same RE of a different layer (outside the coherent group). For 4-layer PUSCH, two coherent groups are considered. If the number of PTRS ports is one, the PTRS port borrows power from the same RE of a different layer in the coherent group. In other words, the PTRS-to-PUSCH transmission power ratio per RE per layer is 10log₁₀ (number of PUSCH layers in the coherent group) [dB]. If the number of PTRS ports is two, in contrast, each PTRS port borrows power from the same RE of a different layer in the coherent group, and also borrows power from a different RE of the same layer, the RE being used for a PTRS on another layer. In other words, the PTRS-to-PUSCH transmission power ratio per RE per layer is 10log₁₀{(number of PUSCH layers in the coherent group)*(number of PTRS ports)} [dB].

In a case of UL-PTRS-power=“01,” the PTRS port(s) borrows power from the same RE of a different layer. Thus, it is always supported that the PTRS-to-PUSCH transmission power ratio per RE per layer is 10log₁₀ (number of PUSCH layers) [dB].

### DL Power Distribution

In DL power distribution, by setting the power of a reference signal (RS) to be higher than the power of another channel(s), channel estimation and detection can be performed more easily and more accurately. To avoid power fluctuations in a receiver (UE), transmission is preferably performed at a fixed power in all OFDM symbols.

In Rel-15 NR, a UE assumes that a PDSCH demodulation reference signal (DM-RS) (DL DM-RS) is mapped to a physical resource according to DM-RS configuration type 1 or configuration type 2 given by a higher layer parameter dmrs-Type. The UE assumes that a PDSCH DM-RS sequence r(m) is scald by a factor β_{PDSCH}^{DMRS} to conform to a defined transmission power. This scaling corresponds to multiplying the sequence r(m) by the factor β_{PDSCH}^{DMRS}.

For a DM-RS associated with a PDSCH, the UE may assume that a ratio of a PDSCH EPRE to a DM-RS energy per resource element (EPRE) (PDSCH EPRE to DM-RS EPRE ratio, ratio of PDSCH EPRE to DM-RS EPRE) β_{DMRS} [dB] is given from a table defined in a specification according to the number of DM-RS code division multiplexing (CDM) groups with no data. The DM-RS scaling factor (amplitude ratio) β_{PDSCH}^{DMRS} is given by 10\hat{ } (−β_{DMRS}/20). According to the table in the specification, for example, when the number of DM-RS CDM groups with no data is two, β_{DMRS} is −3 dB and β_{PDSCH}^{DMRS} is approximately the square root of 2, irrespective of DM-RS configuration type, and hence the amplitude of the DM-RS is scaled by approximately the square root of 2 (power of the DM-RS is scaled to be approximately twice).

In Rel-15 NR, only when a higher layer parameter (phaseTrackingRS in DMRS configuration information for PDSCH (DMRS-DownlinkConfig)) indicates use of a phase-tracking reference signal ((PT-RS), DL PT-RS), the UE assumes that the PT-RS is present only in the resource block (RB) to be used for a PDSCH. When a PT-RS is present, the UE assumes that a PDSCH PT-RS is scaled by a factor β_{PT-RS,i} to conform to a defined transmission power. This scaling corresponds to multiplying a sequence rx by the factor β_{PT-RS,i}.

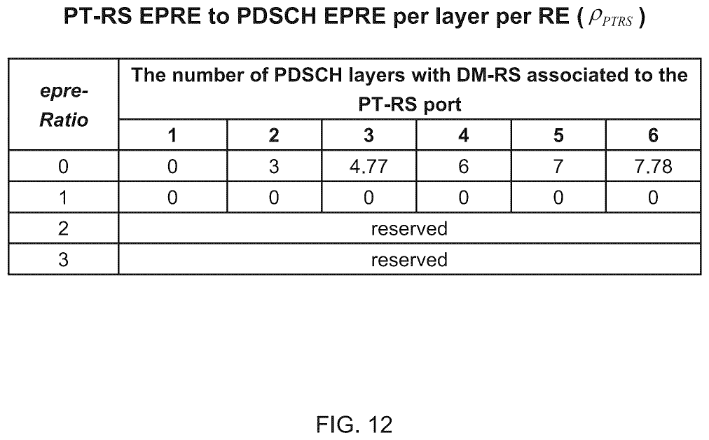

If a UE is configured with a higher layer parameter epre-Ratio when the UE is made a schedule by using a PT-RS port (PT-RS antenna port) associated with a PDSCH, a ratio of a PT-RS EPRE to a PDSCH EPRE per layer per RE for the PT-RS port (PT-RS EPRE to PDSCH EPRE ratio, ratio of PT-RS EPRE to PDSCH EPRE per layer per RE for PT-RS port) ρ_{PTRS} is given from a table defined in a specification (FIG. 12) according to epre-Ratio, and a PT-RS scaling factor (amplitude ratio) β_{PTRS} (β_{PT-RS,i}) is given by 10\hat{ } (ρ_{PTRS}/20). When the UE is not configured with epre-Ratio, the UE assumes that epre-Ratio is set at a state ‘0.’ According to the table in the specification, for example, when the number of PDSCH layers is two, and epre-Ratio is 0, ρ_{PTRS} is 3 dB and ρ_{PTRS} is approximately the square root of 2, and hence the amplitude of the PT-RS is scaled by approximately the square root of 2 (power of the PT-RS is scaled to be approximately twice).

In UL transmission with more than four layers, a PTRS-to-PUSCH transmission power ratio for full-/partial-/non-coherent is not clear. Unless such a transmission power ratio is clear, degradation in communication quality may occur.

Thus, the inventors of the present invention came up with a method of determining a transmission power ratio between a PTRS and a PUSCH for full-/partial-/non-coherent in UL transmission with more than four layers.

Embodiments according to the present disclosure will be described in detail with reference to the drawings as follows. The radio communication methods according to respective embodiments may each be employed individually, or may be employed in combination.

In the present disclosure, “A/B” and “at least one of A and B” may be interchangeably interpreted. In the present disclosure, “A/B/C” may mean “at least one of A, B, and C.”

In the present disclosure, “notify,” “activate,” “deactivate,” “indicate,” “select,” “configure,” “update,” “determine,” and the like may be interchangeably interpreted. In the present disclosure, “support,” “control,” “controllable,” “operate,” “operable,” and the like may be interchangeably interpreted.

In the present disclosure, radio resource control (RRC), an RRC parameter, an RRC message, a higher layer parameter, a field, an information element (IE), a configuration, and the like may be interchangeably interpreted. In the present disclosure, a Medium Access Control control element (MAC Control Element (CE)), an update command, an activation/deactivation command, and the like may be interchangeably interpreted.

In the present disclosure, the higher layer signaling may be, for example, any one or combinations of Radio Resource Control (RRC) signaling, Medium Access Control (MAC) signaling, broadcast information, and the like.

In the present disclosure, the MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (RMSI)), other system information (OSI), or the like.

In the present disclosure, the physical layer signaling may be, for example, downlink control information (DCI), uplink control information (UCI), or the like.

In the present disclosure, an index, an identifier (ID), an indicator, a resource ID, and the like may be interchangeably interpreted. In the present disclosure, a sequence, a list, a set, a group, a cluster, a subset, and the like may be interchangeably interpreted.

The number of layers for PUSCH transmission in the following embodiments may be more than four or may be four or less. For example, PUSCH transmission of two CWs in the present disclosure may be performed by the number of layers being four or less (for example, two). Further, the maximum number of layers is not limited to four or more, and less than four may be applied. An example with the number of layers for PUSCH transmission being eight may be applied to the number of layers being five/six/seven.

Transmission (UL transmission, PUSCH transmission) in the following embodiments may assume that a plurality of panels are used but need not assume this (the transmission may be performed irrespective of panel).

Note that, in the present disclosure, “have capability of . . . ” and “support/report capability of . . . ” may be interchangeably interpreted.

In the present disclosure, full coherent and FC may be interchangeably interpreted. In the present disclosure, partial coherent and PC may be interchangeably interpreted. In the present disclosure, non-coherent and NC may be interchangeably interpreted.

In the present disclosure, a coherent group, an antenna coherent group, an antenna port group, an antenna port group, and an antenna port set may be interchangeably interpreted.

In the present disclosure, a precoder, a precoding matrix, W, and a codebook may be interchangeably interpreted. In the present disclosure, a port, an antenna port, a layer, and an antenna may be interchangeably interpreted.

In the present disclosure, a PTRS-to-PUSCH transmission power ratio 1/a (linear value), a PTRS-to-PUSCH power transmission ratio 10log₁₀ (1/a) [dB], a PTRS-to-PUSCH transmission power ratio a (linear value), and a PTRS-to-PUSCH transmission power ratio 10log₁₀a [dB] may be interchangeably interpreted. In the present disclosure, a PTRS-to-PUSCH transmission power ratio ρ_{PTRS}^{PUSCH} [dB] and a factor −α_{PTRS}^{PUSCH} related to a PTRS-to-PUSCH transmission power ratio may be interchangeably interpreted.

In the present disclosure, a certain port borrowing power from another port, a certain port using power of another port, and a certain port redistributing power from another port may be interchangeably interpreted.

### Radio Communication Method

A UE may receive a configuration/indication of transmission of a PUSCH using more than four layers. The UE may determine a transmission power ratio between a PTRS and a PUSCH.

### Embodiment #1

This embodiment relates to a full-coherent case.

In full-coherent UL transmission with X (X>4) layers, a PTRS-to-PUSCH transmission power ratio may be 1/X in a linear value. The linear value 1/X and 10log₁₀(1/X) [dB] may be interchangeably interpreted.

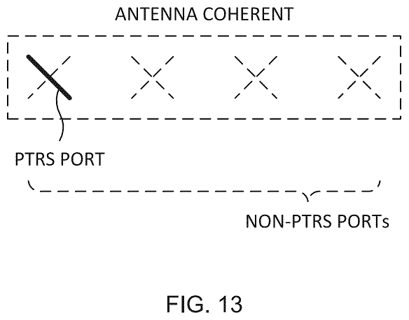

In the example in FIG. 13, eight full-coherent antenna ports are used for UL transmission, and one of the antenna ports is a PTRS port while the others are non-PTRS ports. In this case, PUSCH transmission power/PTRS transmission power=⅛ may hold.

According to this embodiment, even when a UE uses full-coherent precoder for more than four layers, the UE can appropriately determine a transmission power ratio between a PTRS and a PUSCH.

### Embodiment #2

This embodiment relates to a non-coherent case.

In full-coherent UL transmission with X (X>4) layers, a PTRS-to-PUSCH transmission power ratio may be any of some options below.

### Option 1

The transmission power ratio may be 1/X in a linear value. The linear value 1/X and 10log₁₀(1/X) [dB] may be interchangeably interpreted.

### Option 2

The transmission power ratio may depend on the number of PTRS ports.

### Example

The PTRS-to-PUSCH transmission power ratio may be 1/the number of PTRS ports.

When the number of PTRS ports is one, the PTRS-to-PUSCH transmission power ratio may be 1. When the number of PTRS ports is two, the PTRS-to-PUSCH transmission power ratio may be 2.

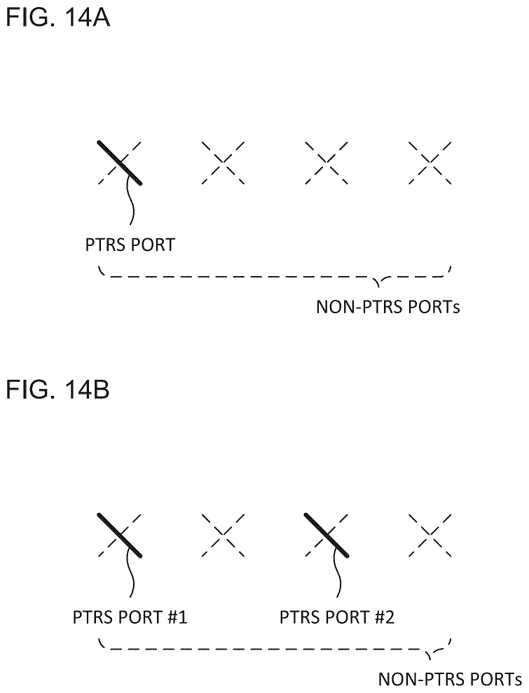

In the example in FIG. 14A, eight non-coherent antenna ports are used for UL transmission, and one of the antenna ports is a PTRS port while the others are non-PTRS ports. In this case, PUSCH transmission power/PTRS transmission power=1 may hold.

In the example in FIG. 14B, eight non-coherent antenna ports are used for UL transmission, and two of the antenna ports are PTRS ports while the others are non-PTRS ports. In this case, PUSCH transmission power/PTRS transmission power=1 may hold. By assuming that two PTRS ports use different REs, one PTRS port may have a power increase with the RE for the other PTRS port being muted.

According to this embodiment, even when a UE uses a non-coherent precoder for more than four layers, the UE can appropriately determine a transmission power ratio between a PTRS and a PUSCH.

### Embodiment 3

This embodiment relates to a partial-coherent case.

In full-coherent UL transmission with X (X>4) layers, a PTRS-to-PUSCH transmission power ratio may be any of some options below.

### Option 1

The transmission power ratio may be 1/X in a linear value. The linear value 1/X and 10log₁₀(1/X) [dB] may be interchangeably interpreted.

### Option 2

The transmission power ratio may depend on the number of PTRS ports and the number of coherent groups.

### Example

The number of coherent groups may be two, and the number of antenna ports per coherent group may be four.

In a case of a plurality of coherent groups each having the same number of antenna ports per coherent group, the PTRS-to-PUSCH transmission power ratio may be 1/(the number of PTRS ports of PUSCH layers per coherent group).

When the number of PTRS ports is one, the PTRS-to-PUSCH transmission power ratio may be ¼=0.25. When the number of PTRS ports is two, the PTRS-to-PUSCH transmission power ratio may be ⅛=0.125. Since one PTRS port is sufficient per coherent group, a case of more than two PTRS ports for two coherent groups need not be defined.

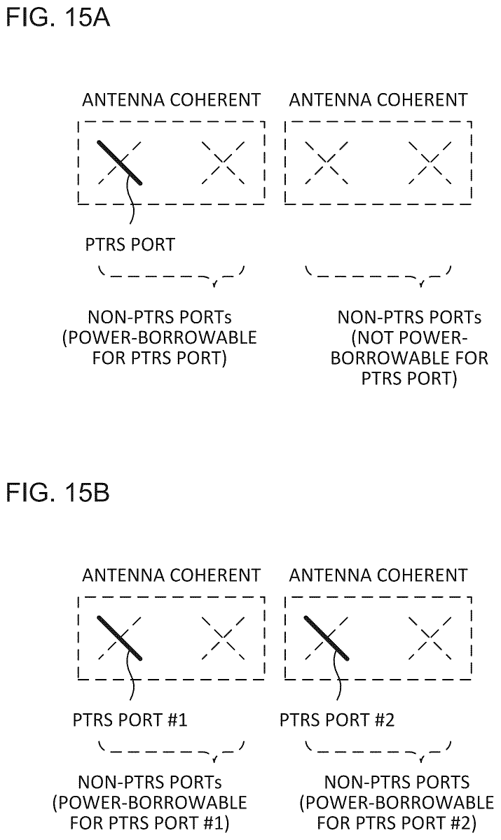

In the example in FIG. 15A, eight partial-coherent antenna ports are used for UL transmission, the number of coherent groups is two, the number of antenna ports per coherent group is four, and one coherent group includes one PTRS port. In this case, PUSCH transmission power/PTRS transmission power=¼ may hold. A PTRS port may use power not used in a non-PTRS port in the same coherent group, in a PTRS transmission symbol. A PTRS port need not use power not used in a non-PTRS port in a different coherent group, in a PTRS transmission symbol.

In the example in FIG. 15B, eight partial-coherent antenna ports are used for UL transmission, the number of coherent groups is two, the number of antenna ports per coherent group is four, and each coherent group includes one PTRS port. In this case, PUSCH transmission power/PTRS transmission power=⅛ may hold. A PTRS port may use power not used in a non-PTRS port in the same coherent group, in a PTRS transmission symbol. A PTRS port need not use power not used in a non-PTRS port in a different coherent group, in a PTRS transmission symbol. By assuming that two PTRS ports use different REs, one PTRS port may have a power increase with the RE for the other PTRS port being muted.

### Option 3

The transmission power ratio may depend on the number of PTRS ports and the number of coherent groups.

### Example

The number of coherent groups may be four, and the number of antenna ports per coherent group may be two.

In a case of a plurality of coherent groups each having the same number of antenna ports per coherent group, the PTRS-to-PUSCH transmission power ratio may be 1/(the number of PTRS ports of PUSCH layers per coherent group).

When the number of PTRS ports is one, the PTRS-to-PUSCH transmission power ratio may be ½=0.5. When the number of PTRS ports is two, the PTRS-to-PUSCH transmission power ratio may be ¼=0.25. Since one PTRS port is sufficient per coherent group, a case of more than two PTRS ports for two coherent groups need not be defined.

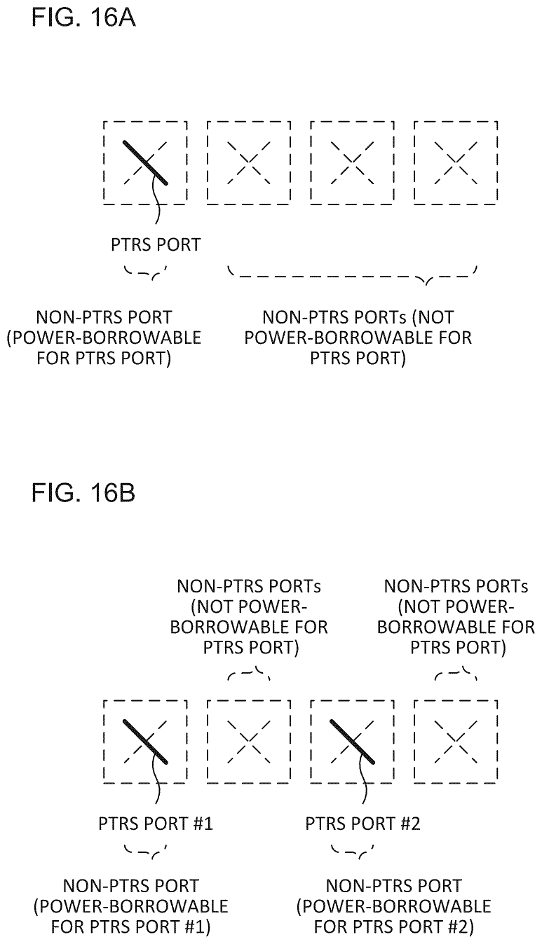

In the example in FIG. 16A, eight partial-coherent antenna ports are used for UL transmission, the number of coherent groups is four, the number of antenna ports per coherent group is two, and one coherent group includes one PTRS port. In this case, PUSCH transmission power/PTRS transmission power=½ may hold. A PTRS port may use power not used in a non-PTRS port in the same coherent group, in a PTRS transmission symbol. A PTRS port need not use power not used in a non-PTRS port in a different coherent group, in a PTRS transmission symbol.

In the example in FIG. 16B, eight partial-coherent antenna ports are used for UL transmission, the number of coherent groups is four, the number of antenna ports per coherent group is two, each of two coherent groups includes one PTRS port. In this case, PUSCH transmission power/PTRS transmission power=¼ may hold. A PTRS port need not use power not used in a non-PTRS port in a different coherent group, in a PTRS transmission symbol. By assuming that two PTRS ports use different REs, one PTRS port may have a power increase with the RE for the other PTRS port being muted.

### Option 4

The transmission power ratio may depend on the number of PTRS ports, the number of coherent groups, and the number of ports in each coherent group.

### Example

The number of coherent groups may be three, and one coherent group may include four PUSCH layers (PUSCH antenna ports) while the other two coherent groups may each include two PUSCH layers (PUSCH antenna ports).

The PTRS-to-PUSCH transmission power ratio may be 1/(the number of PTRS ports*the number of PTRS ports of PUSCH layers per coherent group) in a linear value.

When the number of PTRS ports is one, the PTRS-to-PUSCH transmission power ratio may be at least one of some cases below.

### Case 1-1

When the PTRS port is associated with antenna ports of a coherent group with a larger number of antenna ports, the transmission power may follow the same rule as that of a case of one PTRS port in option 2.

### Case 1-2

When the PTRS port is associated with an antenna port(s) of a coherent group with a smaller number of antenna ports, the transmission power may follow the same rule as that of a case of one PTRS port in option 3.

Only a specific coherent group may be associated with the PTRS port. For example, the specific coherent group may be a coherent group with a larger number of antenna ports or may be a coherent group with the largest number of antenna ports. Here, the number of the larger number of antenna ports may be four or may be another number.

When the number of PTRS ports is two, the PTRS-to-PUSCH transmission power ratio may depend on which coherent group share the PTRS ports.

### Case 2-1

When both PTRS ports are associated with an antenna port(s) of a coherent group with a smaller number of antenna ports, the transmission power may follow the same rule as that of a case of two PTRS ports in option 3. Here, the number of the smaller number of antenna ports may be two or may be another number.

### Case 2-2

When one of two PTRS ports is associated with antenna ports of a coherent group with a larger number of antenna ports, one of the two approaches below may be considered. Here, the number of the larger number of antenna ports may be four or may be another number.
Approach 1

The transmission power ratio may be different for each PTRS port. For example, the PTRS-to-PUSCH transmission power ratio may be 1/(the number of PTRS ports*the number of PUSCH layers of the coherent group that shares the PTRS ports).
Approach 2

The transmission power ratio may be the same for both PTRS ports. For example, the PTRS-to-PUSCH transmission power ratio may be 1/(the number of PTRS ports*the maximum number/the minimum number of PUSCH layers of the coherent group that shares the PTRS ports).

Only a specific coherent group may be associated with the PTRS ports. For example, a plurality of PTRS ports may be associated with antenna ports in different coherent groups, and the coherent groups each may include more than one antenna ports. For example, a plurality of PTRS ports may be associated with antenna ports in different coherent groups, and the coherent groups may include the more same number of antenna ports.

When the number of PTRS ports is more than two, the PTRS-to-PUSCH transmission power ratio may be 1/(the number of PTRS ports*the number of PTRS ports of PUSCH layers per coherent group) in a linear value. Since one PTRS port is sufficient per coherent group, a case of more than two PTRS ports for two coherent groups need not be defined.

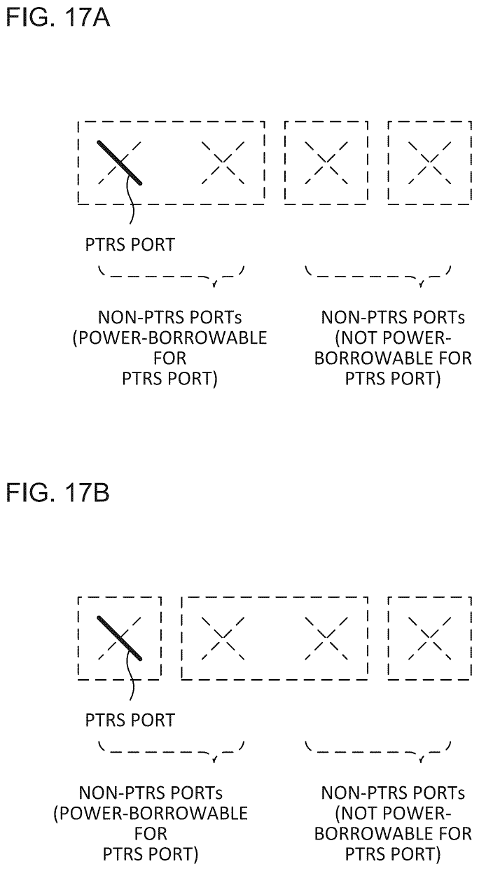

In the example in FIG. 17A, eight partial-coherent antenna ports are used for UL transmission, the number of coherent groups is three, one coherent group includes four antenna ports, two coherent group each include two antenna ports, and the one coherent group including four antenna ports includes one PTRS port. A PTRS port may use power not used in a non-PTRS port in the same coherent group, in a PTRS transmission symbol. A PTRS port need not use power not used in a non-PTRS port in a different coherent group, in a PTRS transmission symbol.

In the example in FIG. 17B, eight partial-coherent antenna ports are used for UL transmission, the number of coherent groups is three, one coherent group includes four antenna ports, two coherent group each include two antenna ports, and one of the coherent groups each including two antenna ports includes one PTRS port. A PTRS port need not use power not used in a non-PTRS port in the same coherent group, in a PTRS transmission symbol.

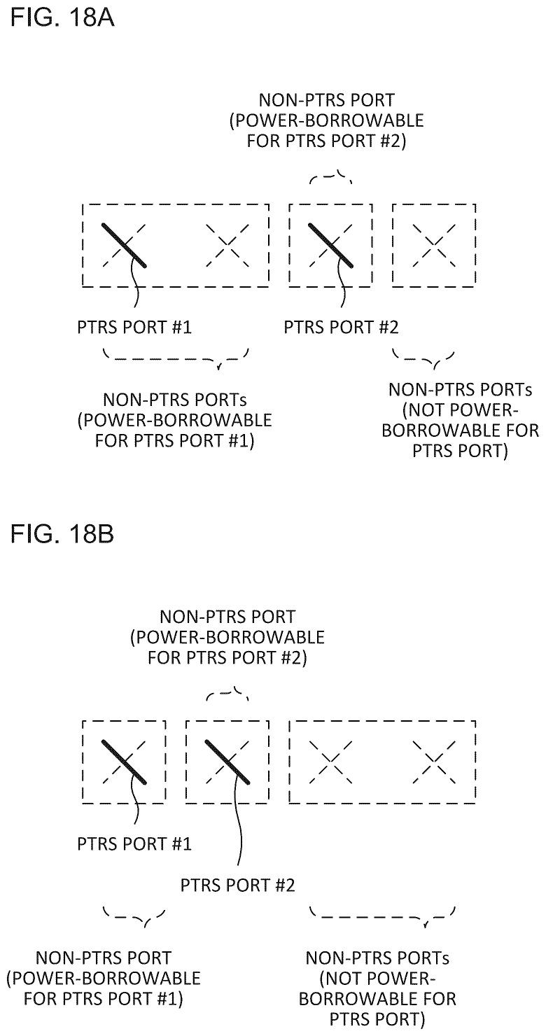

In the example in FIG. 18A, eight partial-coherent antenna ports are used for UL transmission, the number of coherent groups is three, one coherent group includes four antenna ports, two coherent groups each include two antenna ports, the one coherent group including four antenna ports includes one PTRS port, and one of the coherent groups each including two antenna ports includes one PTRS port. A PTRS port may use power not used in a non-PTRS port in the same coherent group, in a PTRS transmission symbol. A PTRS port need not use power not used in a non-PTRS port in a different coherent group, in a PTRS transmission symbol.

In the example in FIG. 18B, eight partial-coherent antenna ports are used for UL transmission, the number of coherent groups is three, two coherent groups each include two antenna ports, one coherent group includes four antenna ports, and each of the coherent groups each including two antenna ports includes one PTRS port. A PTRS port need not use power not used in a non-PTRS port in the same coherent group, in a PTRS transmission symbol.

By assuming that two PTRS ports use different REs, one PTRS port may have a power increase with the RE for the other PTRS port being muted.

According to this embodiment, even when a UE uses partial-coherent precoder for more than four layers, the UE can appropriately determine a transmission power ratio between a PTRS and a PUSCH.

### Embodiment #4

This embodiment relates to configurability of α_{PTRS}^{PUSCH}.

For configuration of the options for embodiment #1/#2/#3, an RRC parameter ptrs-Power may be used. An entry reserved for existing ptrs-Power may be used. The number of entries for ptrs-Power may be enhanced.

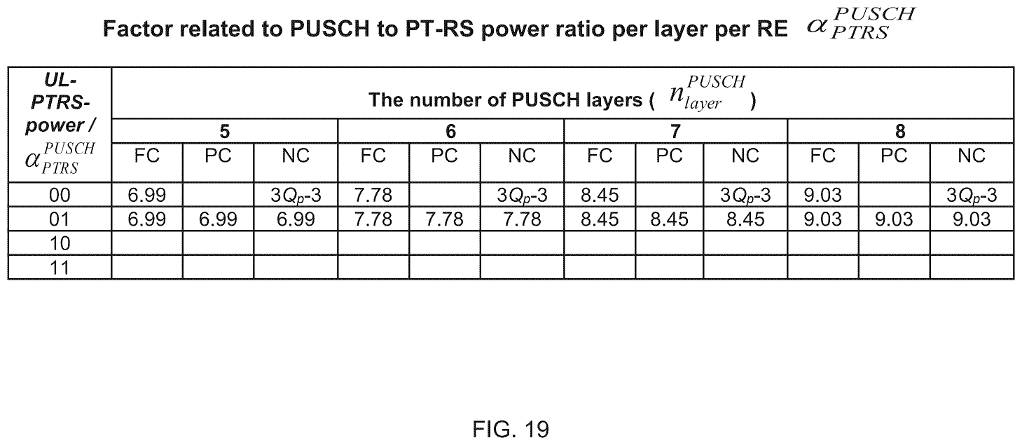

As the example in FIG. 19, values of α_{PTRS}^{PUSCH} may be defined in a specification, for the value (5 to 8) of the number n_{layer}^{PUSCH} of PUSCH layers, full coherent (FC)/partial coherent (PC)/non-coherent (NC), and values 00 and 01 of ptrs-Power. A UE may determine either 10log₁₀ (n_{layer}^{PUSCH}) [dB] or 3Qₚ−3 as the value of a PUSCH-to-PTRS power ratio α_{PTRS}^{PUSCH} for the number n_{layer}^{PUSCH} of PUSCH layers.

### Example

The number of PUSCH layers may be eight.

In partial coherent, the following rules may be applied.
For α_{PTRS}^{PUSCH}=00, option 2/4 of embodiment #3 may be considered.
For α_{PTRS}^{PUSCH}=01, use of power not used in any of all the other layers may be considered.
For α_{PTRS}^{PUSCH}=10, option 3/4 of embodiment #3 may be considered.
   In full coherent, use of power not used in any of all the other layers may be considered.

In non-coherent, the following rules may be applied.
Power not used in any other REs on the same layer is used for another PTRS port(s).
Power not used in any of all the other layers is used.

Separately from the existing association (table) between UL-PTRS-power and α_{PTRS}^{PUSCH} for four layers or less (FIG. 11), association (table) between UL-PTRS-power and α_{PTRS}^{PUSCH} for the number of layers being more than four as in FIG. 19 may be defined in a specification. A UE may switch the tables, based on higher layer signaling. In other words, the UE need not dynamically switch association between UL-PTRS-power and α_{PTRS}^{PUSCH}.

The existing association (table) between UL-PTRS-power and α_{PTRS}^{PUSCH} for four or less layers (FIG. 11) may be enhanced to include the contents of association between UL-PTRS-power and α_{PTRS}^{PUSCH} for the number of layers being more than four as that in FIG. 19, and the resultant association (table) may be defined in a specification. The UE may dynamically switch association between UL-PTRS-power and α_{PTRS}^{PUSCH}, based on the number of PUSCH layers (for example, any of one to eight).

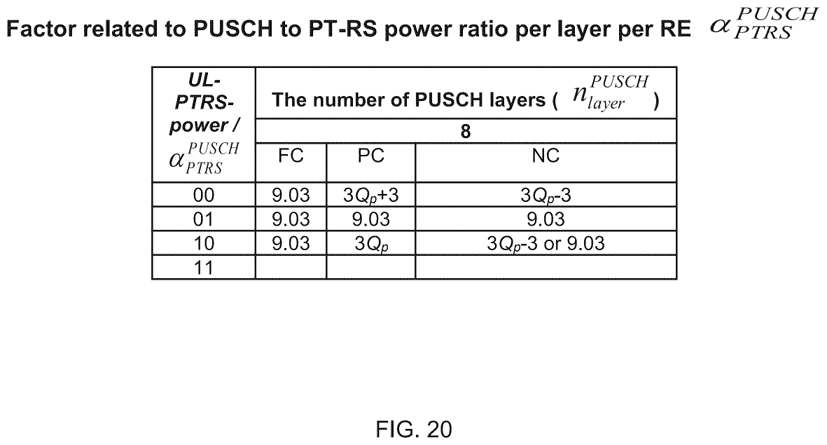

As the example in FIG. 20, values of α_{PTRS}^{PUSCH} may be defined in a specification, for the value of the number n_{layer}^{PUSCH} of PUSCH layers being eight, full coherent (FC)/partial coherent (PC)/non-coherent (NC), and values 00, 01, and 10 of ptrs-Power. A UE may determine any of 10log₁₀(n_{layer}^{PUSCH}) [dB], 3Qₚ−3, 3Qₚ+3, and 3Qₚ as the value of a PUSCH-to-PTRS power ratio α_{PTRS}^{PUSCH} for the number n_{layer}^{PUSCH} of PUSCH layers.

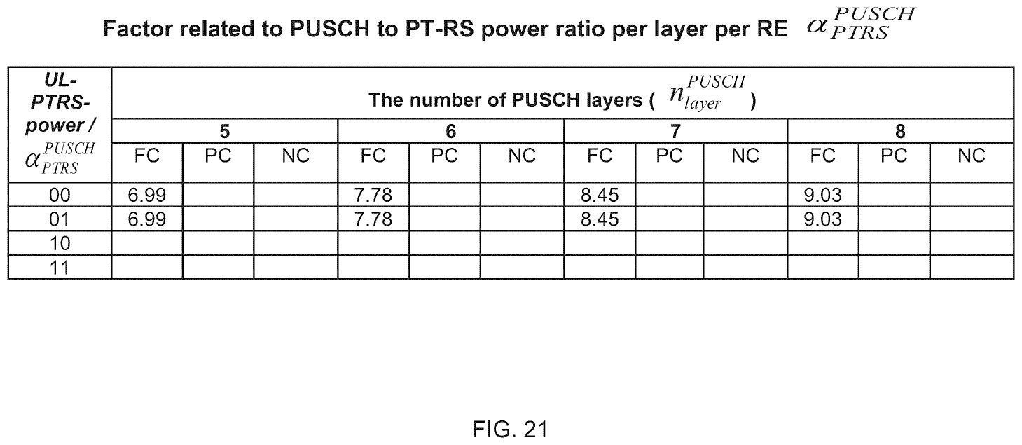

As the example in FIG. 21, values of α_{PTRS}^{PUSCH} may be defined in a specification, for value (5 to 8) of the number n_{layer}^{PUSCH} of PUSCH layers, full coherent (FC), and at least values 00 and 01 of ptrs-Power and FC. In a case of using a full-coherent precoder, a UE may determine 10log₁₀(n_{layer}^{PUSCH}) [dB] as the value of a PUSCH-to-PTRS power ratio α_{PTRS}^{PUSCH} for the number n_{layer}^{PUSCH} of PUSCH layers.

According to this embodiment, it is possible for a UE to appropriately determine a PUSCH-to-PTRS power ratio per layer per RE.

### Supplement

A UE may assume that at least one PTRS port is inserted/configured in an antenna coherent group. In a case of using a partial-coherent precoder, a UE may assume that at least one PTRS port is inserted/configured in an antenna coherent group.

### Notification of Information to UE

Notification of any information to a UE (from a network (NW) (for example, a base station (BS))) (in other words, reception of any information by the UE from the BS) in the above-described embodiments may be performed by any of or a combination of physical layer signaling (for example, DCI), higher layer signaling (for example, RRC signaling, MAC CE), and a specific signal/channel (for example, a PDCCH, a PDSCH, or a reference signal).

When the notification is performed by a MAC CE, the MAC CE may be identified by a new logical channel ID (LCID) not defined in an existing standard being included in a MAC subheader.

When the notification is performed by DCI, the notification may be performed by a specific field of the DCI, a radio network temporary indicator (radio network temporary identifier (RNTI)) used for scrambling of cyclic redundancy check (CRC) bits added to the DCI, the format of the DCI, or the like.

Notification of any information to a UE in the above-described embodiments may be performed periodically, semi-persistently, or aperiodically.

Notification of Information from UE

Notification of any information from a UE (to an NW) (in other words, transmission/reporting of any information to a BS by the UE) in the above-described embodiments may be performed by any of or a combination of physical layer signaling (for example, UCI), higher layer signaling (for example, RRC signaling, MAC CE), and a specific signal/channel (for example, a PUCCH, a PUSCH, a PRACH, or a reference signal).

When the notification is performed by a MAC CE, the MAC CE may be identified by a new LCID not defined in an existing standard being included in a MAC subheader.

When the notification is performed by UCI, the notification may be transmitted by using a PUCCH or a PUSCH.

Notification of any information from a UE in the above-described embodiments may be performed periodically, semi-persistently, or aperiodically.

### Regarding Application of Each Embodiment

At least one of the above-described embodiments may be applied when a specific condition is satisfied. The specific condition may be defined in a standard, or a UE/BS may be notified of the specific condition by using higher layer signaling/physical layer signaling.

At least one of the above-described embodiments may be applied only to a UE that has reported a specific UE capability or supports the specific UE capability.

The specific UE capability may indicate at least one of the following:
supporting of PUSCH transmission using more than four antenna ports
supporting of an 8-port m-layer NC/PC/FC precoder (m=1, 2, . . . )

The specific UE capability may be capability applied over all the frequencies (commonly irrespective of frequency), capability per frequency (for example, one or a combination of cell, band, band combination, BWP, component carrier, and the like), capability per frequency range (for example, Frequency Range 1 (FR1), FR2, FR3, FR4, FR5, FR2-1, FR2-2), capability per subcarrier spacing (SCS), or capability per Feature Set (FS) or Feature Set Per Component-carrier (FSPC).

The specific UE capability may be capability applied over all the duplex schemes (commonly irrespective of duplex scheme) or capability per duplex scheme (for example, time division duplex (TDD) or per frequency division duplex (FDD)).

At least one of the above-described embodiments may be applied when the UE is configured/activated/triggered with specific information related to the above-described embodiment (or carrying out the operation of the above-described embodiment) by higher layer signaling/physical layer signaling. For example, the specific information may be information indicating that the function of each embodiment is enabled, any RRC parameter for a specific release (for example, Rel. 18/19), or the like.

When the UE does not support at least one of the specific UE capabilities above or is not configured with the specific information above, the UE may apply Rel-15/16 operation, for example.

### Supplementary Notes

Regarding one embodiment of the present disclosure, the following supplementary notes of the invention will be given.

### Supplementary Note 1

A terminal including:
a receiving section that receives an indication of transmission of a physical uplink shared channel (PUSCH) using more than four layers; and
a control section that determines a transmission power ratio between a phase tracking reference signal (PTRS) and the PUSCH.

### Supplementary Note 2

The terminal according to supplementary note 1, wherein the control section determines the transmission power ratio, based on the number of antenna ports for the PTRS and the number of layers by using a full-coherent precoder for the transmission of the PUSCH.

### Supplementary Note 3

The terminal according to supplementary note 1 or 2, wherein the control section determines the transmission power ratio, based on at least one of the number of antenna ports for the PTRS and the number of layers by using a non-coherent precoder for the transmission of the PUSCH.

### Supplementary Note 4

The terminal according to any one of supplementary notes 1 to 3, wherein the control section determines the transmission power ratio, based on at least one of the number of antenna ports for the PTRS, the number of layers, the number of coherent groups, and the number of antenna ports in each coherent group by using a partial-coherent precoder for the transmission of the PUSCH.

### Radio Communication System

Hereinafter, a structure of a radio communication system according to one embodiment of the present disclosure will be described. In this radio communication system, the radio communication method according to each embodiment of the present disclosure described above may be used alone or may be used in combination for communication.

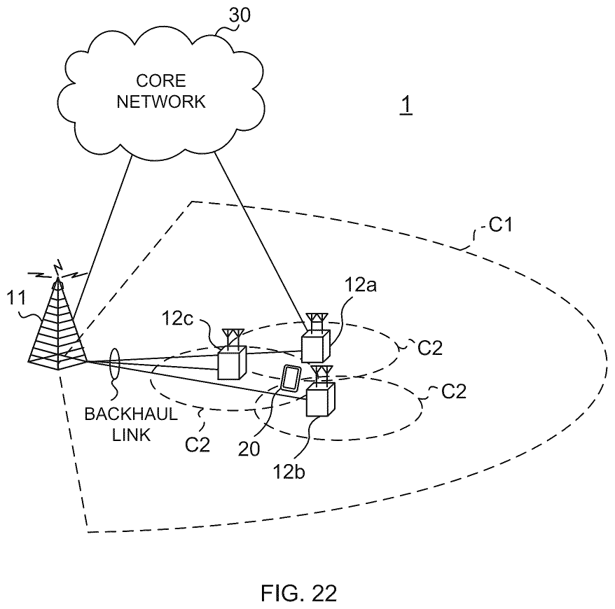

FIG. 22 is a diagram to show an example of a schematic structure of the radio communication system according to one embodiment. The radio communication system 1 (which may be referred to simply as a system 1) may be a system implementing communication using Long Term Evolution (LTE), 5th generation mobile communication system New Radio (5G NR) and so on the specifications of which have been drafted by the Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHz), and FR2 may be a frequency band which is higher than 24 GHz (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The core network 30 may include network functions (NFs) such as User Plane Function (UPF), Access and Mobility management Function (AMF), Session Management Function (SMF), Unified Data Management (UDM), Application Function (AF), Data Network (DN), Location Management Function (LMF), and operation, administration and maintenance (Management) (OAM), for example. Note that a plurality of functions may be provided by one network node. Communication with an external network (for example, the Internet) may be performed via the DN.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data”, and the PUSCH may be interpreted as “UL data”.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### Base Station

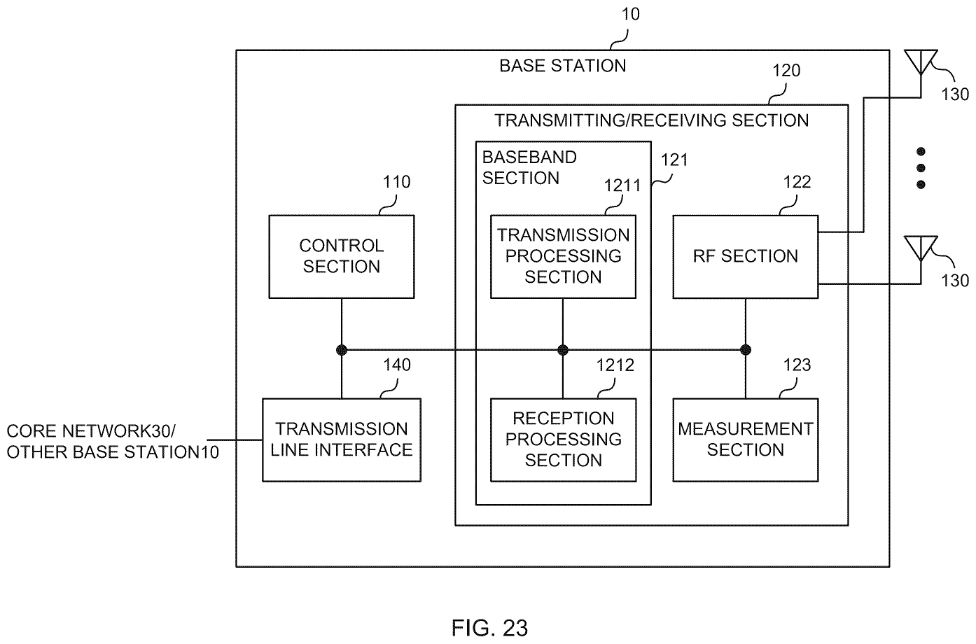

FIG. 23 is a diagram to show an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may perform transmission/reception (backhaul signaling) of a signal with an apparatus included in the core network 30 (for example, a network node providing NF), other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the communication path interface 140.

Note that the transmitting/receiving section 120 may transmit an indication of transmission of a physical uplink shared channel (PUSCH) using more than four layers. The control section 110 may determine a transmission power ratio between a phase tracking reference signal (PTRS) and the PUSCH.

### User Terminal

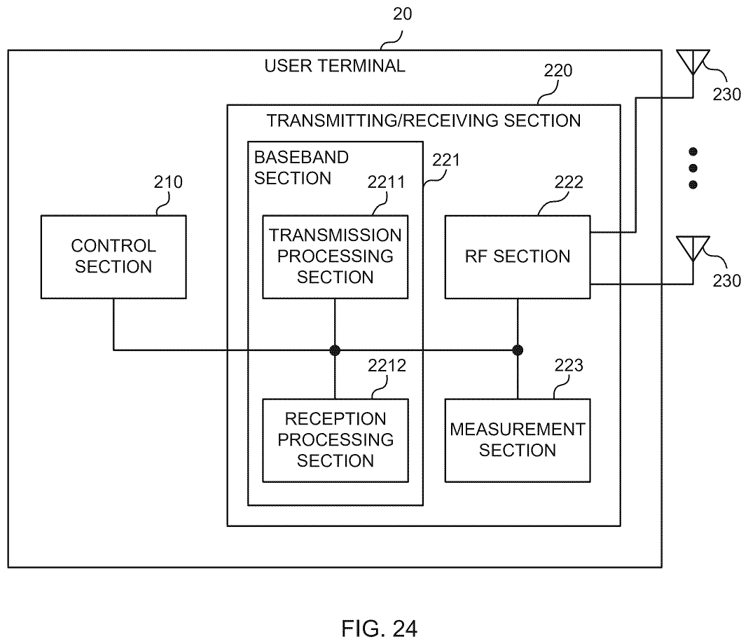

FIG. 24 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a certain channel (for example, PUSCH), the DFT processing as the above-described transmission processing to transmit the channel by using a DFT-s-OFDM waveform if transform precoding is enabled, and otherwise, does not need to perform the DFT processing as the above-described transmission processing.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply reception processing such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

Note that the transmitting/receiving section 220 may receive an indication of transmission of a physical uplink shared channel (PUSCH) using more than four layers. The control section 210 may determine a transmission power ratio between a phase tracking reference signal (PTRS) and the PUSCH.

The control section 210 may determine the transmission power ratio, based on the number of antenna ports for the PTRS and the number of layers by using a full-coherent precoder for the transmission of the PUSCH.

The control section 210 may determine the transmission power ratio, based on at least one of the number of antenna ports for the PTRS and the number of layers by using a non-coherent precoder for the transmission of the PUSCH.

The control section 210 may determine the transmission power ratio, based on at least one of the number of antenna ports for the PTRS, the number of layers, the number of coherent groups, and the number of antenna ports in each coherent group by using a partial-coherent precoder for the transmission of the PUSCH.

### Hardware Structure

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate apparatuses (for example, via wire, wireless, or the like) and using these apparatuses. The functional blocks may be implemented by combining software into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but functions are by no means limited to these. For example, a functional block (component) to implement a function of transmission may be referred to as a “transmitting section (transmitting unit)”, a “transmitter”, or the like. The method for implementing each component is not particularly limited as described above.

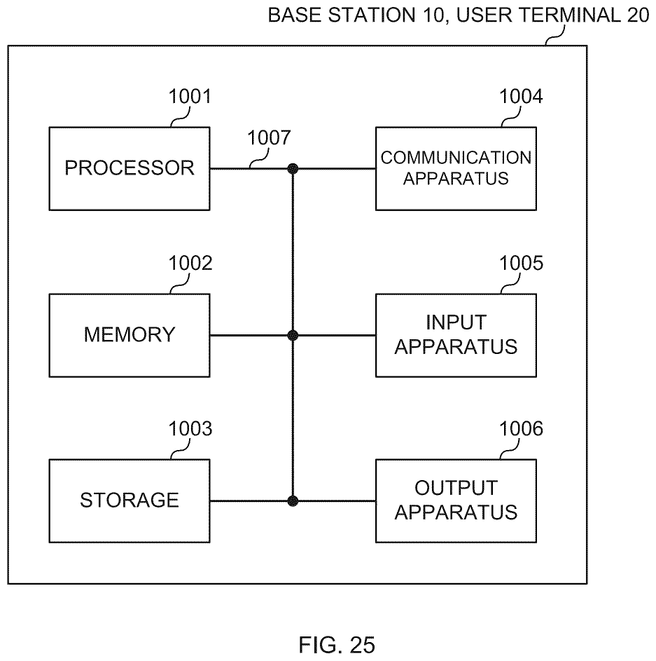

For example, a base station, a user terminal, and so on according to one embodiment of the present disclosure may function as a computer that executes the processes of the radio communication method of the present disclosure. FIG. 25 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably used. The hardware structure of the base station 10 and the user terminal 20 may be configured to include one or more of apparatuses shown in the drawings, or may be configured not to include part of apparatuses.

For example, although one processor 1001 is shown in the drawings, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminal 20 is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least a part of the control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least a part of the operations explained in the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register”, a “cache”, a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “auxiliary storage apparatus”.

The communication apparatus 1004 is hardware (transmitting/receiving device) for allowing inter-computer communication via at least one of wired and wireless networks, and may be referred to as, for example, a “network device”, a “network controller”, a “network card”, a “communication module”, and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the transmitting/receiving section 120 (220), the transmitting/receiving antenna 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor or the like). The output apparatus 1006 is an output device that allows sending output to the outside (for example, a display, a speaker, a Light Emitting Diode (LED) lamp or the like). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between apparatuses.

Also, the base station 10 and the user terminal 20 may be structured to include hardware such as a microprocessor, a Digital Signal Processor (DSP), an Application Specific Integrated Circuit (ASIC), a Programmable Logic Device (PLD), a Field Programmable Gate Array (FPGA), and so on, and a part or all of the functional blocks may be implemented by the hardware. For example, the processor 1001 may be implemented with at least one of these pieces of hardware.

### Variations

It should be noted that a term used in the present disclosure and a term required for understanding of the present disclosure may be replaced by a term having the same or similar meaning. For example, a channel, a symbol, and a signal (or signaling) may be interchangeably used. Further, a signal may be a message. A reference signal may be abbreviated as an RS, and may be referred to as a pilot, a pilot signal or the like, depending on which standard applies. Furthermore, a component carrier (CC) may be referred to as a cell, a frequency carrier, a carrier frequency and so on.

A radio frame may be constituted of one or a plurality of periods (frames) in the time domain. Each of one or a plurality of periods (frames) constituting a radio frame may be referred to as a “subframe”. Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot”. A mini-slot may be constituted of symbols in number less than the slot. A PDSCH (or PUSCH) transmitted in a time unit larger than a mini-slot may be referred to as “PDSCH (PUSCH) mapping type A”. A PDSCH (or PUSCH) transmitted using a mini-slot may be referred to as “PDSCH (PUSCH) mapping type B”.

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably used.

For example, one subframe may be referred to as a “TTI”, a plurality of consecutive subframes may be referred to as a “TTI”, or one slot or one mini-slot may be referred to as a “TTI”. In other words, at least one of a subframe and a TTI may be a subframe (1 ms) in existing LTE, may be a period shorter than 1 ms (for example, 1 to 13 symbols), or may be a period longer than 1 ms. Note that a unit expressing TTI may be referred to as a “slot”, a “mini-slot”, or the like, instead of a “subframe”.

Here, a TTI refers to the minimum time unit of scheduling in radio communication, for example. For example, in LTE systems, a base station performs, for user terminals, scheduling of allocating of radio resources (such as a frequency bandwidth and transmit power that are available for each user terminal) in TTI units. Note that the definition of TTIs is not limited to this.

The TTI may be a transmission time unit for channel-encoded data packets (transport blocks), code blocks, codewords, or the like, or may be a unit of processing in scheduling, link adaptation, or the like. Note that, when a TTI is given, a time interval (for example, the number of symbols) to which transport blocks, code blocks, codewords, or the like are actually mapped may be shorter than the TTI.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI”, a “normal subframe”, a “long subframe”, a “slot” and so on. A TTI that is shorter than a normal TTI may be referred to as a “shortened TTI”, a “short TTI”, a “partial or fractional TTI”, a “shortened subframe”, a “short subframe”, a “mini-slot”, a “sub-slot”, a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB))”, a “sub-carrier group (SCG)”, a “resource element group (REG)”, a “PRB pair”, an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth”, and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for UL) and a DL BWP (BWP for DL). One or a plurality of BWPs may be configured in one carrier for a UE.

At least one of configured BWPs may be active, and a UE may not need to assume to transmit/receive a certain signal/channel outside the active BWP(s). Note that a “cell”, a “carrier”, and so on in the present disclosure may be used interchangeably with a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Further, the information, parameters, and so on described in the present disclosure may be expressed using absolute values or relative values with respect to certain values, or may be expressed using another corresponding information. For example, a radio resource may be specified by a certain index.

The names used for parameters and so on in the present disclosure are in no respect used as limitations. Furthermore, mathematical expressions that use these parameters, and so on may be different from those explicitly disclosed in the present disclosure. Since various channels (PUCCH, PDCCH, and so on) and information elements may be identified by any suitable names, the various names allocated to these various channels and information elements are in no respect used as limitations.

The information, signals, and so on described in the present disclosure may be represented by using any of a variety of different technologies. For example, data, an instruction, a command, information, a signal, a bit, a symbol, a chip, and so on, described throughout the description of the present application, may be represented by a voltage, an electric current, electromagnetic waves, magnetic fields, a magnetic particle, optical fields, a photon, or any combination thereof.

Also, information, signals, and so on can be output at least one of from a higher layer to a lower layer and from a lower layer to a higher layer. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or added. The information, signals, and so on that has been output may be deleted. The information, signals, and so on that has been input may be transmitted to another apparatus.

Notification of information is by no means limited to the aspects/embodiments described in the present disclosure, and other methods may be used as well. For example, notification of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information block (SIB), and so on), Medium Access Control (MAC) signaling and so on), and other signals or combinations of these.

Note that physical layer signaling may be referred to as “Layer 1/Layer 2 (L1/L2) control information (L1/L2 control signals)”, “L1 control information (L1 control signal)”, and so on. Also, RRC signaling may be referred to as an “RRC message”, and can be, for example, an RRC connection setup message, an RRC connection reconfiguration message, and so on. Also, MAC signaling may be notified using, for example, MAC control elements (MAC CEs).

Also, notification of certain information (for example, notification of “X”) does not necessarily have to be performed explicitly, and can be performed implicitly (by, for example, not reporting this certain information or reporting another piece of information).

A decision may be realized by a value (0 or 1) represented by one bit, by a boolean value (true or false), or by comparison of numerical values (e.g., comparison with a certain value).

Software, irrespective of whether referred to as “software”, “firmware”, “middleware”, “microcode”, or “hardware description language”, or called by other terms, should be interpreted broadly to mean instructions, instruction sets, codes, code segments, program codes, programs, subprograms, software modules, applications, software applications, software packages, routines, subroutines, objects, executable files, execution threads, procedures, functions, and the like.

Also, software, instructions, information, and the like may be transmitted and received via a transmission medium. For example, when software is transmitted from a website, a server, or other remote sources by using at least one of wired technologies (coaxial cable, fiber optic cable, twisted-pair cable, digital subscriber line (DSL), and so on) and wireless technologies (infrared radiation, microwaves, and so on), at least one of these wired technologies and wireless technologies is also included in the definition of the transmission medium.

The terms “system” and “network” used in the present disclosure may be used interchangeably. The “network” may mean an apparatus (for example, a base station) included in the network.

In the present disclosure, the terms such as “precoding”, a “precoder”, a “weight (precoding weight)”, “quasi-co-location (QCL)”, a “Transmission Configuration Indication state (TCI state)”, a “spatial relation”, a “spatial domain filter”, a “transmit power”, “phase rotation”, an “antenna port”, an “antenna port group”, a “layer”, “the number of layers”, a “rank”, a “resource”, a “resource set”, a “resource group”, a “beam”, a “beam width”, a “beam angular degree”, an “antenna”, an “antenna element”, a “panel”, and so on may be used interchangeably.

In the present disclosure, the terms such as a “base station (BS)”, a “radio base station”, a “fixed station,” a “NodeB”, an “eNB (eNodeB)”, a “gNB (gNodeB)”, an “access point”, a “transmission point (TP)”, a “reception point (RP)”, a “transmission/reception point (TRP)”, a “panel”, a “cell”, a “sector”, a “cell group”, a “carrier”, a “component carrier”, and so on can be used interchangeably. The base station may be referred to as the terms such as a “macro cell”, a “small cell”, a “femto cell”, a “pico cell”, and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, transmitting information to the terminal by the base station may be interchangeably interpreted as instructing the terminal to perform control/operation based on the information by the base station.

In the present disclosure, the terms “mobile station (MS)”, “user terminal”, “user equipment (UE)”, and “terminal” may be used interchangeably.

A mobile station may be referred to as a “subscriber station”, “mobile unit”, “subscriber unit”, “wireless unit”, “remote unit”, “mobile device”, “wireless device”, “wireless communication device”, “remote device”, “mobile subscriber station”, “access terminal”, “mobile terminal”, “wireless terminal”, “remote terminal”, “handset”, “user agent”, “mobile client”, “client”, or some other appropriate terms in some cases.

At least one of a base station and a mobile station may be referred to as a “transmitting apparatus”, a “receiving apparatus”, a “radio communication apparatus” or the like. Note that at least one of a base station and a mobile station may be a device mounted on a moving object or a moving object itself, and so on.

The moving object is a movable object with any moving speed, and naturally, it also includes a moving object stopped. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a satellite, a drone, a multicopter, a quadcopter, a balloon, and an object mounted on any of these, but these are not restrictive. The moving object may be a moving object that autonomously travels based on a direction for moving.

The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor.

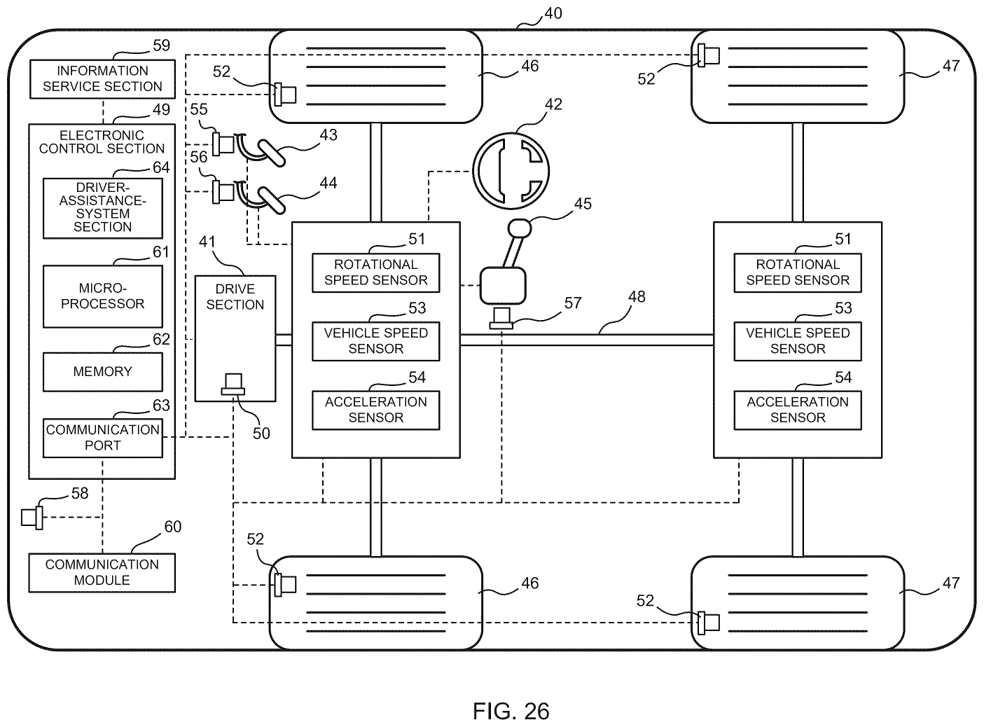

FIG. 26 is a diagram to show an example of a vehicle according to one embodiment. A vehicle 40 includes a driving section 41, a steering section 42, an accelerator pedal 43, a brake pedal 44, a shift lever 45, right and left front wheels 46, right and left rear wheels 47, an axle 48, an electronic control section 49, various sensors (including a current sensor 50, a rotational speed sensor 51, a pneumatic sensor 52, a vehicle speed sensor 53, an acceleration sensor 54, an accelerator pedal sensor 55, a brake pedal sensor 56, a shift lever sensor 57, and an object detection sensor 58), an information service section 59, and a communication module 60.

The driving section 41 includes, for example, at least one of an engine, a motor, and a hybrid of an engine and a motor. The steering section 42 includes at least a steering wheel (also referred to as a handle), and is configured to steer at least one of the front wheels 46 and the rear wheels 47, based on operation of the steering wheel operated by a user.

The electronic control section 49 includes a microprocessor 61, a memory (ROM, RAM) 62, and a communication port (for example, an input/output (IO) port) 63. The electronic control section 49 receives, as input, signals from the various sensors 50 to 58 provided in the vehicle. The electronic control section 49 may be referred to as an Electronic Control Unit (ECU).

Examples of the signals from the various sensors 50 to 58 include a current signal from the current sensor 50 for sensing current of a motor, a rotational speed signal of the front wheels 46/rear wheels 47 acquired by the rotational speed sensor 51, a pneumatic signal of the front wheels 46/rear wheels 47 acquired by the pneumatic sensor 52, a vehicle speed signal acquired by the vehicle speed sensor 53, an acceleration signal acquired by the acceleration sensor 54, a depressing amount signal of the accelerator pedal 43 acquired by the accelerator pedal sensor 55, a depressing amount signal of the brake pedal 44 acquired by the brake pedal sensor 56, an operation signal of the shift lever 45 acquired by the shift lever sensor 57, and a detection signal for detecting an obstruction, a vehicle, a pedestrian, and the like acquired by the object detection sensor 58.

The information service section 59 includes: various devices for providing (outputting) various pieces of information such as driving information, traffic information, and entertainment information, such as a car navigation system, an audio system, a speaker, a display, a television, and a radio; and one or more ECUs that control these devices. The information service section 59 provides various pieces of information/services (for example, multimedia information/multimedia service) to an occupant of the vehicle 40, using information acquired from an external apparatus via the communication module 60 and the like.

The information service section 59 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

A driving assistance system section 64 includes: various devices for providing functions for preventing an accident and reducing a driver's driving load, such as a millimeter wave radar, Light Detection and Ranging (LiDAR), a camera, a positioning locator (for example, a Global Navigation Satellite System (GNSS) and the like), map information (for example, a high definition (HD) map, an autonomous vehicle (AV) map, and the like), a gyro system (for example, an inertial measurement apparatus (inertial measurement unit (IMU)), an inertial navigation apparatus (inertial navigation system (INS)), and the like), an artificial intelligence (AI) chip, and an AI processor; and one or more ECUs that control these devices. The driving assistance system section 64 transmits and receives various pieces of information via the communication module 60, and implements a driving assistance function or an autonomous driving function.

The communication module 60 can communicate with the microprocessor 61 and the constituent elements of the vehicle 40 via the communication port 63. For example, the communication module 60 transmits and receives data (information), via the communication port 63, to and from the driving section 41, the steering section 42, the accelerator pedal 43, the brake pedal 44, the shift lever 45, the right and left front wheels 46, the right and left rear wheels 47, the axle 48, the microprocessor 61 and the memory (ROM, RAM) 62 in the electronic control section 49, and the various sensors 50 to 58, which are included in the vehicle 40.

The communication module 60 is a communication device that can be controlled by the microprocessor 61 of the electronic control section 49 and that can perform communication with an external apparatus. For example, the communication module 60 performs transmission and reception of various pieces of information to and from the external apparatus via radio communication. The communication module 60 may be either inside or outside the electronic control section 49. The external apparatus may be, for example, the base station 10, the user terminal 20, or the like described above. The communication module 60 may be, for example, at least one of the base station 10 and the user terminal 20 described above (may function as at least one of the base station 10 and the user terminal 20).

The communication module 60 may transmit at least one of signals input from the various sensors 50 to 58 to the electronic control section 49, information obtained based on the signals, and information based on an input from the outside (a user) obtained via the information service section 59, to the external apparatus via radio communication. The electronic control section 49, the various sensors 50 to 58, the information service section 59, and the like may be referred to as input sections that receive input. For example, the PUSCH transmitted by the communication module 60 may include information based on the input.

The communication module 60 receives various pieces of information (traffic information, signal information, inter-vehicle distance information, and the like) transmitted from the external apparatus, and displays the received information on the information service section 59 included in the vehicle. The information service section 59 may be referred to as an output section that outputs information (for example, outputs information to devices, such as a display and a speaker, based on the PDSCH received by the communication module 60 (or data/information decoded from the PDSCH)).

The communication module 60 stores the various pieces of information received from the external apparatus in the memory 62 that can be used by the microprocessor 61. Based on the pieces of information stored in the memory 62, the microprocessor 61 may control the driving section 41, the steering section 42, the accelerator pedal 43, the brake pedal 44, the shift lever 45, the right and left front wheels 46, the right and left rear wheels 47, the axle 48, the various sensors 50 to 58, and the like provided in the vehicle 40.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D)”, “Vehicle-to-Everything (V2X)”, and the like). In this case, user terminals 20 may have the functions of the base stations 10 described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, the user terminal in the present disclosure may be interpreted as a base station. In this case, the base station 10 may have the functions of the user terminal 20 described above.

Operations which have been described in the present disclosure to be performed by a base station may, in some cases, be performed by an upper node of the base station. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

Each aspect/embodiment described in the present disclosure may be used independently, may be used in combination, or may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced, modified, created, or defined based on these. A plurality of systems may be combined (for example, a combination of LTE or LTE-A and 5G, and the like) for application.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first”, “second”, and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “deciding (determining)” as in the present disclosure herein may encompass a wide variety of actions. For example, “deciding (determining)” may be interpreted to mean making “decisions (determinations)” about judging, calculating, computing, processing, deriving, investigating, looking up, search and inquiry (for example, searching a table, a database, or some other data structures), ascertaining, and so on.

Furthermore, “deciding (determining)” may be interpreted to mean making “decisions (determinations)” about receiving (for example, receiving information), transmitting (for example, transmitting information), input, output, accessing (for example, accessing data in a memory), and so on.

In addition, “deciding (determining)” as used herein may be interpreted to mean making “decisions (determinations)” about resolving, selecting, choosing, establishing, comparing, and so on. In other words, “deciding (determining)” may be interpreted to mean making “decisions (determinations)” about some action.

“Decide/deciding (determine/determining)” may be used interchangeably with “assume/assuming”, “expect/expecting”, “consider/considering”, and the like.

“The maximum transmit power” described in the present disclosure may mean a maximum value of the transmit power, may mean the nominal maximum transmit power (the nominal UE maximum transmit power), or may mean the rated maximum transmit power (the rated UE maximum transmit power).

The terms “connected”, “coupled”, or any variation of these terms as used in the present disclosure mean any direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access”.

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other”. It should be noted that the phrase may mean that “A and B are each different from C”. The terms “separate”, “coupled”, and so on may be interpreted similarly to “different”.

In the case where the terms “include”, “including”, and variations thereof are used in the present disclosure, these terms are intended to be comprehensive, in a manner similar to the term “comprising”. Furthermore, the term “or” used in the present disclosure is not intended to be an “exclusive or”.

For example, in the present disclosure, where an article such as “a”, “an”, and “the” is added by translation, the present disclosure may include that a noun after the article is in a plural form.

In the present disclosure, “equal to or less than”, “less than”, “equal to or more than”, “more than”, “equal to”, and the like may be used interchangeably. In the present disclosure, words such as “good”, “bad”, “large”, “small”, “high”, “low”, “early”, “late”, “wide”, “narrow”, and the like may be used interchangeably irrespective of positive degree, comparative degree, and superlative degree. In the present disclosure, expressions obtained by adding “i-th” (i is any integer) to words such as “good”, “bad”, “large”, “small”, “high”, “low”, “early”, “late”, “wide”, “narrow”, and the like may be used interchangeably irrespective of positive degree, comparative degree, and superlative degree (for example, “best” may be used interchangeably with “i-th best”, and vice versa).

In the present disclosure, “of”, “for”, “regarding”, “related to”, “associated with”, and the like may be used interchangeably.

Now, although the invention according to the present disclosure has been described in detail above, it is apparent to a person skilled in the art that the invention according to the present disclosure is by no means limited to the embodiments described in the present disclosure. Modifications, alternatives, replacements, etc., of the invention according to the present disclosure may be possible without departing from the subject matter and the scope of the present invention defined based on the descriptions of claims. The description of the present disclosure is provided only for the purpose of explaining examples, and should by no means be construed to limit the invention according to the present disclosure in any way.

1. A terminal comprising:
a receiving section that receives an indication of transmission of a physical uplink shared channel (PUSCH) using more than four layers; and
a control section that determines a transmission power ratio between a phase tracking reference signal (PTRS) and the PUSCH.

2. The terminal according to claim 1, wherein
the control section determines the transmission power ratio, based on the number of antenna ports for the PTRS and the number of layers by using a full-coherent precoder for the transmission of the PUSCH.

3. The terminal according to claim 1, wherein
the control section determines the transmission power ratio, based on at least one of the number of antenna ports for the PTRS and the number of layers by using a non-coherent precoder for the transmission of the PUSCH.

4. The terminal according to claim 1, wherein
the control section determines the transmission power ratio, based on at least one of the number of antenna ports for the PTRS, the number of layers, the number of coherent groups, and the number of antenna ports in each coherent group by using a partial-coherent precoder for the transmission of the PUSCH.

5. A radio communication method for a terminal, the radio communication method comprising:
receiving an indication of transmission of a physical uplink shared channel (PUSCH) using more than four layers; and
determining a transmission power ratio between a phase tracking reference signal (PTRS) and the PUSCH.

6. A base station comprising:
a transmitting section that transmits an indication of transmission of a physical uplink shared channel (PUSCH) using more than four layers; and
a control section that determines a transmission power ratio between a phase tracking reference signal (PTRS) and the PUSCH.
